(19) United States
(12) Patent Application Publication
(10) Pub. No.: US 2008/0233541 A1
(43) Pub. Date: Sep. 25, 2008

(54) Method and Device for Enhancing the Treatment of Teeth and Gums

(75) Inventors: Guy De Vreese, Sint-Martens-Latem (BE); Michael Williams, Pollock Pines, CA (US)

Correspondence Address: KNOBBE MARTENS OLSON & BEAR LLP, 2040 MAIN STREET, FOURTEENTH FLOOR, IRVINE, CA, 92614, US

(73) Assignee: Remedent, Inc.

(21) Appl. No.: 11/579,916

(22) PCT Filed: Mar. 16, 2005
(86) PCT No.: PCT/EP05/02788

§ 371 Date: Jan. 3, 2008

(30) Foreign Application Priority Data
May 11, 2004 (EP) PCT/EP04/05029
May 11, 2004 (EP) PCT/EP04/05030

(51) Int. Cl. A61C 17/00

(52) U.S. Cl. 433/216; 433/6

(57) ABSTRACT

An autonomous device which includes a trough, shaped for the immersion of teeth and/or gums of a dental arch, or a dental brace and one or more electrical components which provide functionality is disclosed. The device is useful in methods for whitening teeth, relieving pain, treating bacteria, treating bad breath, and healing. Inserts for use with the device are also disclosed.

### BACKGROUND TO THE INVENTION

The bleaching of teeth is a procedure for the management of stained or discoloured teeth. Generally, it involves the administration of bleaching agents under professional supervision or the self-application of an over-the-counter teeth whitening product to the teeth of an upper and/or lower dental arch.

In professionally supervised bleaching, a practitioner takes a dental impression of the subject and a custom-fitting dental appliance is made therefrom which fits to the subject's dental arches. An appliance for either the upper, lower arches or both dental arches is made, depending on the request of the subject.

Once the custom-fitting appliance has been prepared, the dentist applies the bleaching agent thereto, fits the appliance to the dental arches and the subject typically waits for a period of up to 120 minutes while the treatment takes place.

Since the bleaching agent used by a dental practitioner may be more caustic than the bleaching agents available for home use, the practitioner has to monitor the subject in case the agent comes into contact with oral cavity and/or is ingested.

The long period over which the subject is required to hold the appliance, commonly causes the subject discomfort due to breathing and swallowing difficulties, and excessive salivation.

The time required by the subject, the dental practitioner and technicians to take an impression of a subject, prepare a custom-fitting appliance, and apply the treatment, means that the process bleaching is costly and inconvenient for the subject.

Once the treatment has finished, the subject is provided with said appliance and an amount of bleaching agent sufficient for continued home treatment. Typically, concentration of bleaching agent is reduced for unsupervised home use. The home treatment usually continues daily for the prescribed amount of time, and the length of a typical session is between 30 and 120 minutes per day.

The method of whitening by a dental profession presents a number of disadvantages mentioned above which includes a high time-cost for the subject, discomfort, and the potential for injury to a subject during each treatment session.

Bleaching agents which are available over-the-counter provide an alternative means for whitening teeth. Such over the counter treatments typically comprise a disposable, soft, universal fit U-shaped tray which contain a pre-measured quantity of bleaching agent. The subject fits the tray to his or her dental arches and the tray is kept in position for up to sixty minutes.

However, the foam trays commonly used in home bleaching systems have several drawbacks. They may fail to direct and confine the application of home bleaching agents on the surfaces of a patient's teeth, which is critical to its safety and efficacy. In addition, a subject will often experience discomfort due to excessive salivation, restricted breathing through the mouth, and restricted swallowing.

Some home treatment systems use a tray having predispensed quantity of bleaching agent. A particular limitation of these systems is the reduced shelf life and associated efficacy of existing bleaching agents. Over a limited period of time, the efficacy of the agent may be attenuated primarily due to moisture in the agent or the surrounding air.

Currently available bleaching agents utilized in both the professional and over the counter markets are either viscous liquids or gels. The peroxy compounds are hydrous and typically provided in gel matrices of differing concentrations. Carbamide peroxide gels dispensed in the professional market range between about 10 to 25 percent while the concentration of carbamide peroxide in over the counter products range between about 6 and 15 percent. Bleaching agents are commercially available and packaged in separate dispensing containers such as bottles and tubes, and most often, gels. The peroxy compounds utilized in the professional and over the counter markets are hydrated and generally provided in gel matrices differing in concentration. Carbamide peroxide gels dispensed in the professional market range between about 10 and 25 percent, while the concentration of carbamide peroxide in over the counter products range between about 6 and 15 percent. When applied at home, the patient dispenses an estimated quantity of bleaching agent to the rigid custom dental appliance, and then places the appliance over the dental arches being treated.

Existing carbamide peroxide systems utilize gels comprising hydrogen peroxide coupled to urea in either anhydrous glycerin base or a soluble, aqueous Carbopol base. When carbamide peroxide is hydrated, the hydrogen peroxide breaks down into urea and peroxide, which subsequently breaks down into water and oxygen. This instability of the agent in hydrated form limits the efficacy of existing bleaching agents, particularly when exposed to water.

Thus, there exists many problems with systems for delivery of home bleaching agents, which include subject discomfort, potential for subject injury and the shelf-life of systems.

Curing and Dental Light

In dental tooth restoration, a dental practitioner places a light-curable filling material in the area of the tooth to be restored, such as, for example, a cavity, and cures the filling material with light of an appropriate wavelength. Curing light is provided by a light curing device which is introduced into the oral cavity, and is capable of projecting light onto the light curable material.

Light curing devices commonly in use comprise a light source such as a bulb, and an optic fiber terminating in a hand-held tip which directs light from the bulb to a position desired by the practitioner. Usually, the bulb has a service life of approximately 20 to 25 hours, and thus has to be replaced frequently. While curing, the practitioner is required to direct manually the light beam therefrom and hold the tip in the appropriate position during the curing process. The tips are expensive and prone to permanent malfunction if damaged as a result of even minor accidents. The tips must also be produced in a range of sizes and shapes to allow application of light to different locations in the mouth and for different indications. The tips are typically of relatively short length so that the light source when attached and in use is in close proximity to a patient's face.

During the curing process, the subject must be positioned on the dentist's chair, close to the light source. She or he is required to maintain an uncomfortable open-mouthed position during the procedure. The practitioner has to restrict his movements when using the light otherwise the fibre optic trailing from the light source becomes tangled.

Because of their expense, the tight curing tips are used repetitively and, therefore, must be sterilisable by the processes of gas sterilisation, autoclaving or other suitable process. Particular precautions are required to guard against the spread of HIV Virus, Hepatitis or Tuberculosis.

Thus, light curing devices of the art have a number of disadvantages. They are large instruments, taking up space in the dental surgery, and they require manual and prolonged use by the dental practitioner during the curing process. The time spent holding a light beam over a curable material could be better employed by both the practitioner and the subject. Furthermore, they require constant, regular maintenance.

Dental Light

Non-specific light sources such as operating lights or a mirror provided on a headband for use by the dental practitioner provide general illumination in the mouth but do not provide the concentrated focus that is sometimes required for specific purposes. Some instruments provide light directly into a subject mouth; these are hand held and require an assistant to orient the beam. Other instruments are mounted on a flexible stand and can be fixed a positioned by the practitioner. However, should a subject move his or her head during a procedure, the light is required to be repositioned. Lights which enter the open mouth also restrict the movements by and line of sight of the practitioner by virtue of the size of the light and cable attached thereto. Some instruments such as dental drills contain their own light channelling devices that are commonly composed of glass fiber optic components. These components also suffer from the disadvantages of comparative fragility and are prone to damage.

Thus, there are several disadvantages of lights of the prior art, due to their size, movability and/or fragility.

Dental Therapies

Providing therapy to the teeth and gums is difficult, because the therapy has to be applied by an external device or an external agent, usually by a dental practitioner. This often means a subject is required to sit in a dental chair, and is remain open-mouthed while the practitioner performs the therapy. Thus devices and method for delivery therapy require time of the dental practitioner, expense for the subject and cause discomfort to the subject. Thus, there is a need for a new method and device for delivering dental therapy.

Physical Stimulation Treatments

Treatments such as teeth cleaning, plaque removal and treatment of bacteria (e.g. bacterial infections, bad breath) often require the subject to be present in the dental chair and a dental professional to manually apply a treatment. Dental procedures require a subject to remain open-mouthed while the practitioner performs a therapy. This causes a subject discomfort due to breathing and swallowing difficulties, excessive salivation and sometimes ‘white coat anxiety’. Furthermore, treatments by dental professions are expensive for a subject in terms of cost and time.

Home treatments for cleaning teeth, plaque removal and bad breath are often not as effective as those available in a dental surgery, because the concentration of active agent is reduced for home use. Therefore, treatment may take longer or may not be capable of effectively treating teeth.

In view of the prior art, there is a need for a device and method for reducing the time required and discomfort associated with cleaning, plaque removal from teeth and gums, and treatment of bacteria by a dental professional. There is also a need for a device and method for home treatment which is able to enhance the action of active agents present in low doses for over-the counter use.

Some dental interventions cause wounds, operational openings and swellings in the gums, which eventually heal over time. Before healing has completed, however, discomfort in a mouth of a subject may affect breathing, eating, and speech. Pain associated with dental arches can be intense. Prescription pain killers are usually required to manage the pain, which may not be suitable for a subject. Similarly, orthodontal treatments cause lesions in the gums. Such lesions typically take a long time to heal particularly where a removable or adjustable brace is applied. There is, therefore, a need in the prior art to increase the rate of healing after dental interventions.

Dental pain associated with the dental arch, gums, teeth and nerves of a subject, is often intensely uncomfortable. In managing the pain, prescription medicines are typically prescribed and orally administered. However, these can take time to act. Furthermore, the dose is strong pain killers is regulated and restricted. Furthermore, pain killers may not be suitable for use with a subject (e.g. due to allergy). While high doses of pain killer might be necessary to manage pain, the limits placed on dosage often preclude complete pain relief. There is, therefore, a need for effectively managing pain associated with the dental arch of a subject which overcomes the problems of the prior art.

### AIMS OF THE INVENTION

It is an aim of the present invention to provide a method and device for expediting the bleaching of a subject's teeth. In expediting the process, the problems associated with both the professional and home whitening procedures such as cost and discomfort to the subject are overcome.

It is another aim of the present invention to provide an autonomous dental curing light which can be fitted to one or both dental arches of a subject, so relieving the dental practitioner of using the cumbersome curing light devices of the art, and of the necessity for manual involvement during the curing of the light-curable material.

It is another aim of the present invention to provide an autonomous illumination device which can be fitted on the dental arch of a subject. Such a device provides intense and focused beam which illuminates the opposite dental arch, and a minimal intrusion of the oral cavity.

It is another aim of the present invention to provide an autonomous device which can be fitted on the dental arch of a subject. Such a device provides therapies such as massage, pain relief, anti-bacterial treatment, treatment for bad breath and tissue stimulation with enhanced effects with a minimal intrusion of the oral cavity.

### SUMMARY OF THE INVENTION

The invention relates to a dental device comprising:
(a)—a trough, shaped for the immersion of teeth and/or gums of a dental arch, or
   —a dental brace, shaped for attachment to the teeth of a dental arch, and
(b) one or more electroluminescent devices, ELDs.

Preferred embodiments can include one or more of the following devices:
A dental device according to the invention wherein the light emitted from an ELD pulsates.
A dental device according to the invention wherein the frequency of said pulsation is between 1 and 500 times per second.
A device according to the invention wherein the number of ELDs is two or more and said ELDs illuminate in patterned sequence.
A dental device according to the invention, further comprising one or more reflectors.
A dental device according to the invention, further comprising one or more power sources.
A dental device according to the invention wherein said power source is one or more batteries.
A dental device according to the invention further comprising a means for connection to an external power source.
A dental device according to the invention wherein said external power source is an electric toothbrush.
A dental device according to the invention further comprising an inverter.
A dental device according to the invention further comprising one or more switches.
A dental device according to the invention further comprising one or more means to regulate said electrical components.
A dental device according to the invention further comprising one or more means to provide functionality for a timed period, after which time, the device switches off.
A dental device according to the invention wherein said trough or brace has a means to receive or support an insert comprising one or more agents.
A dental device according to the invention, further comprising at least one Light Emitting Diode, LED.
A dental device according to the invention wherein the number of visible LEDs is two or more and said LEDs illuminate in patterned sequence.
A dental device according to the invention wherein said ELD or LED where present emits light of a wavelength suitable for curing dental restorative materials.
A dental device according to the invention where in said ELD or LED where present emits light of wavelength between 400 to 510 nm.
A dental device according to the invention where in said ELD or LED where present emits light of a wavelength suitable for enhancing the activity of one or more bleaching agents.
A dental device according to the invention where in said LED emits heat.
A dental device according to the invention, further comprising at least one means for providing heat stimulation.
A dental device according to the invention wherein said means to provide heat stimulation is a heating strip comprising one or more heating elements.
A dental device according to the invention, further comprising at least one means for providing physical stimulation.
A dental device according to the invention, wherein a means to provide physical stimulation is an ultrasonic transducer.
A dental device according to the invention, wherein a means to provide physical stimulation is an ultrasonic motor.
A dental device according to the invention, wherein a means to provide physical stimulation is a magnetic motor.
A dental device according to the invention, further comprising one or more protrusions capable of abrasive cleaning, massaging and/or polishing teeth and/or gums.
A dental device according to the invention, further comprising at least one means to provide electrical stimulation.
A dental device according to the invention wherein said means to provide electrical stimulation is a pair of electrodes.
A dental device according to the invention, wherein said ELD, or where present, one or more of said LED, means for providing heat stimulation, means for providing physical stimulation, means to provide electrical stimulation is positioned such that its' functionality is directed towards the anterior surface of said teeth and/or gums.
A dental device according to the invention, wherein said ELD, or where present, one or more of said LED, means for providing heat stimulation, means for providing physical stimulation, means to provide electrical stimulation is positioned such that its' their functionality is directed towards the top surface of said teeth and/or gums.
A dental device according to the invention, wherein said ELD, or where present, one or more of said LED, means for providing heat stimulation, means for providing physical stimulation, means to provide electrical stimulation is positioned such that its' functionality is directed towards the posterior surface of said teeth and/or gums.
A dental device according to the invention in which the device comprises a trough, further comprising a second device comprising a trough according to any of claims 1 to 22, said second device arranged so that the teeth of both the upper and lower arches are each immersable in a trough.
A dental device according to the invention wherein a single switch and/or regulating means are provided.
A dental device according to the invention wherein at least part of the device is made from a translucent material allowing light from said ELD or LEDs to be viewed from the anterior of said device.
A dental device according to the invention, wherein at least part of the device is made from one or more of the following materials: coloured polymer, patterned polymer, composite, translucent polymer, opaque polymer.

In another aspect the invention relates to the use of a device according to the invention for curing light-curable dental materials.

Preferred embodiments can include any of the uses according to claims 38 to 47.

In yet another aspect the invention relates to a method for providing dental treatment comprising the use of a dental device according to the invention.

Preferred embodiments can include any of the methods according to claims 73 to 75.

### SUMMARY OF THE FIGURES

FIGS. 1 to 3: a single trough device of the invention.

FIG. 4: a device comprising an insert.

FIGS. 5A and 5B: a double-troughed device of the invention.

FIG. 6A to 6D: Views of a single trough device of the invention.

FIGS. 7A and 7B: Views of an a dental illumination device of the invention.

FIG. 8: An exploded view of a double-troughed device of the invention.

FIGS. 9 and 10: a single trough device of the invention.

FIGS. 11 to 13: a brace device according to the invention.

FIG. 14A to 14F: examples of possible components of a kit according to the invention including straight stick inserts (A), U-shaped inserts (B), a charger/programmer (C), a button battery (D), a cleaning brush (E), and an instruction booklet (F).

FIGS. 15 and 16: kits according to the invention.

### DETAILED DESCRIPTION OF THE INVENTION

The present invention relates to an autonomous dental device comprising:

(a) a trough, shaped for the immersion of teeth and/or gums of a dental arch, and

(b) one or more electrical components which provide functionality.

The inventors have found the functionality provided by the electrical components on the device can enhance treatments such as teeth whitening, the curing of restorative dental materials, pain relief, treating infections, and illumination of a subject's teeth during dental work. Examples of such functionality include light (e.g. visible, UV and IR), heat, physical stimulation and electrical stimulation. Furthermore, the autonomous nature of the device (i.e. self contained) means the subject is not restricted to procedures such as curing, or teeth whitening which normally require their presence on a dentist's chair and the equipment associate therewith. This further frees the dental chair for other patients. The use of a subject's own dental arch as a support for said functionality alleviates a dental practitioner from holding and directing an external source of illumination, heat, UV light, IR light etc., so enabling a practitioner to use both hands for performing dental manipulations.

According to a particular embodiment of the invention, an autonomous dental device comprises:

(a) a trough, shaped for the immersion of teeth and/or gums of a dental arch,

(b) one or more means to provide physical stimulation, and

(c) optionally, one or more means to provide heat.

The inventors have found the physical stimulation provided by a device of the invention can enhance treatments such as, for example, cleaning, massage, pain relief, anti-bacterial treatment, anti-plaque treatment, healing, treatment for bad breath, and tissue stimulation. The combined use of heat, still further enhances treatment. Furthermore, the autonomous nature of the device (i.e. having a self contained power source) means the subject is not restricted to procedures such which normally require their presence on a dentist's chair and the equipment associate therewith. This further frees the dental chair for other patients. The use of a subject's own dental arch as a support for said functionality alleviates a dental practitioner from holding and directing an external source of, for example, ultrasound or heat, so enabling a practitioner to use both hands for performing dental manipulations.

According to another embodiment of the invention, the above mentioned troughs are replaced by a brace formed at least partly from wire, which clips to the upper or lower teeth. According to one aspect of the invention, components are integrated attached to or integrated into the wire.

Trough

A trough according to the present invention is any container shaped for the immersion of teeth and/or gums of the dental arch. The container may be formed by any material that is compatible with the body. Examples of material suitable for a trough include, but are not limited to polycarbonate, foam, polypropylene, rubberised polymer, composite, polymer. It is an aspect of the invention that the trough is formed of the same material throughout. It is an aspect of the invention that the trough is made from two or more materials. For example, a flexible material might be used in the portions of the trough expected to change shape to accommodate a dental arch (e.g. foam in the inner wall of the trough), and a stiff material used to support components (e.g. polypropylene in the outer walls of the trough).

It is an aspect of the invention that the walls of a trough are formed from substantially a single continuous sheet so forming a sealed device. In the latter case, the trough may, for example, be formed in a mould, and components and working parts introduced therein during a moulding process.

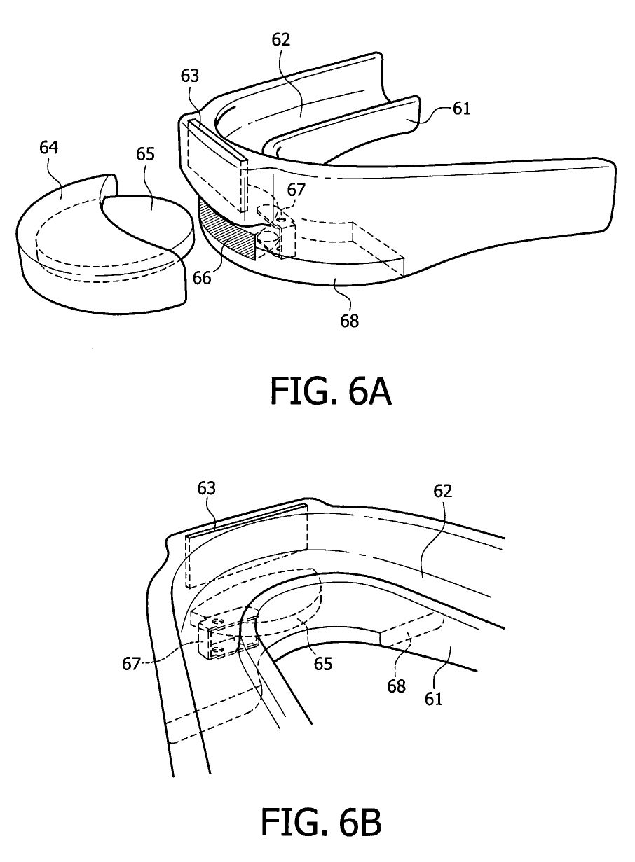

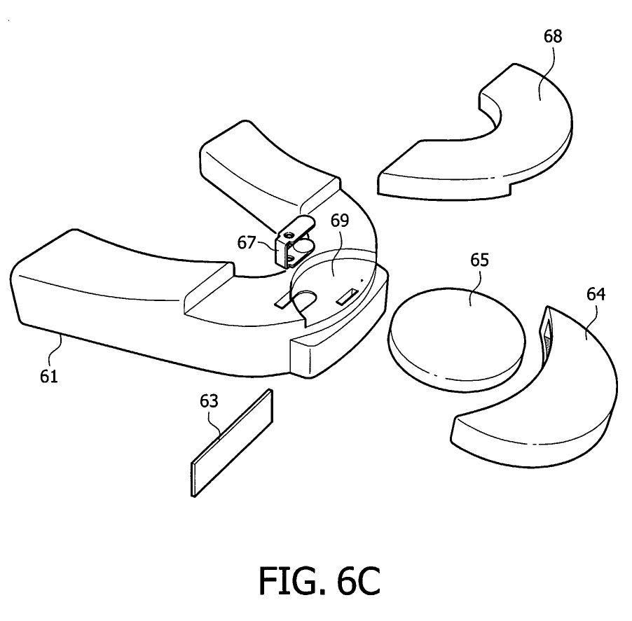

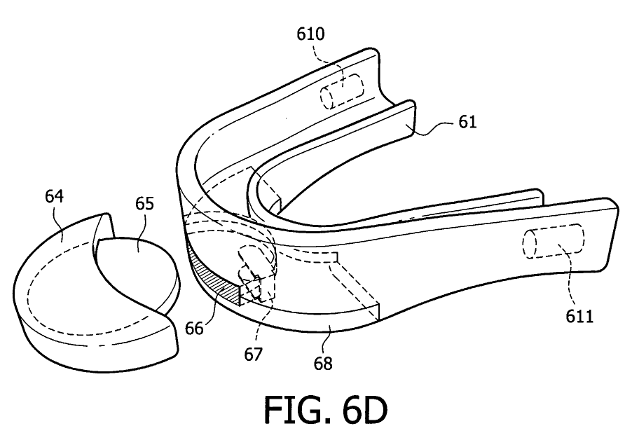

It is another aspect of the invention that a device of the invention is formed of different interfitting parts. In the latter case, a device may be assembled from separately moulded parts which are clipped and/or sealed together. For example, the inner trough wall and the outer trough wall might be separately formed, so that during production, components and working parts can be readily assembled into the device. Furthermore, reversibly interfitting parts allow access to be gained to the workings of the device, for example, for repair or to change a battery etc. In another example, FIG. 6C depicts a device of the invention comprising a sub mould part 68, a soft form trough 61, and a battery cover 64. A separate sub mould part 68 facilitates convenient assembly of a device during production, and the compartment cover 64 allows the battery to be changed.

In one embodiment of the present invention, the trough is of a size, shape and flexibility to allow an adaptable fit on a wide variety of dental arches. Examples of suitable shapes include U-shaped, horse-shoe shaped troughs. A single size has the benefit of reduced mass-production costs, reduced storage space requirements and simpler consumer choice.

In another embodiment of the present invention the trough is available in a variety of sizes and/or shapes. A choice of sizes and shapes provides a close-fitting appliance, and allows the appropriate degree of treatment to be delivered for a given size of dental arch.

In another embodiment of the present invention the trough is custom-made for a particular dental arch. A custom-fitting device has the best fit which allows the functionality to be precisely delivered, and hence the appropriate degree of treatment to the dental arch.

Methods of preparing a universal fitting trough, trough with a variety of sizes, and custom-fitting troughs are known to the skilled person.

In another embodiment of the present invention, a trough further comprises a means to receive one or more said electrical components, stimulation or heat-providing devices. Said means are any which allow said components to be positioned so that their functionality is provided towards the desired location. Examples of such means include but are not limited to one or more hollows in the wall of the trough, one or more grooves, holes, lugs, ridges, slots, gripping means etc, provided in said hollow or a wall of the trough.

In another embodiment of the present invention, the trough further comprises a receiving or supporting means to hold one or more agents. In another embodiment of the present invention, the trough further comprises a receiving means to receive one or more inserts, said inserts comprising said agents. An example of receiving means include the base of the trough, one or more grooves, one or more holes, one or more gripping means, one or more lugs, one more ridges, one or more slots etc. In another embodiment of the present invention, the brace further comprises a receiving means or supporting for one or more inserts, said inserts comprising said agents. A receiving means may be a slot for holding a gel strip. A supporting means may be a wire for supporting a gel strip in contact with the teeth in situ.

Such a receiving means in the dental device allows agents which are activated or enhanced by, for example, light, heat, electrical and/or physical stimulation to be provided to a subject's teeth and/or gums, while being closely and precisely coupled to the source of light, heat, electrical or physical stimulation. It further allows the agents which transmit, for example, light, heat, electrical and/or physical stimulation to be provide in intimate contact with the source of the light, heat, electrical and/or physical stimulation and a subject's teeth and/or gums.

Brace

Where a dental device is a brace, it comprises wire elements suitable for clipping said brace to the teeth. The wire elements may be held in a support which is shaped to fit the behind the teeth. A brace according to the invention is of the removable construction, well known in the art in orthodontic treatments, and as a ‘fake brace’ for cosmetic effect.

Typically, a brace of the invention comprises one wire element which spans the front of the teeth. Optionally, other wire elements include one or more clips suitable for attachment to other teeth (e.g. rear molars, wisdom teeth etc). Material suitable for wire elements are known in the art of orthodontics and include, but are not limited to titanium, stainless steel, gold, silver, platinum, copper, ceramic, plastic, plastic/metal composite.

The support typically adopts the shape of the of the posterior (inner) face of the teeth. The support, as known in the art, is designed to lie behind the upper or lower teeth. It is usually in intimate contact with the posterior face of the upper or lower teeth, along at least part of the teeth. The support may be horse-shape shaped. Where the brace is designed for the upper teeth, the support may adopt at least part of the shape of the upper palate. Material suitable for the support include, but are not limited to polycarbonate, polypropylene, rubberised polymer, composite, polymer.

In one embodiment of the present invention, the brace is of a size, shape and flexibility to allow an adaptable fit on a wide variety of dental arches. Examples of suitable shapes include U-shaped, horse-shoe shaped. A single size has the benefit of reduced mass-production costs, reduced storage space requirements and simpler consumer choice.

In another embodiment of the present invention the brace is available in a variety of sizes and/or shapes. A choice of sizes and shapes provides a close-fitting appliance, and allows the appropriate degree of treatment to be delivered for a given size of dental arch.

In another embodiment of the present invention the brace is custom-made for a particular dental arch. A custom-fitting device has the best fit which allows the functionality to be precisely delivered, and hence the appropriate degree of treatment to the dental arch.

Methods of preparing a universal fitting brace, brace with a variety of sizes, and custom-fitting brace are known to the skilled person.

In another embodiment of the present invention, a brace further comprises a means to receive one or more said electrical components, stimulation means and/or heat-providing devices. Said means are any which allow said components to be positioned so that their functionality is provided towards the desired location. Examples of such means include but are not limited to one or more one or more lugs, ridges, gripping means etc, provided in the wire or support of said brace.

According to another aspect of the invention one or more wire elements may also provide aforementioned functionality. According to one aspect of the invention, one or more wires of the brace can provide heat (e.g. a wire element incorporating a heating element). According to one aspect of the invention, one or more wires of the brace provide light (e.g. a wire element incorporating an electroluminescent light). According to one aspect of the invention, one or more wires of the brace provide electrical stimulation (e.g. a wire element incorporating one or more electrodes).

In another embodiment of the present invention, the brace further comprises a receiving means to receive one or more agents. An example of a receiving means includes a clip suitable for attachment of an agent in a solid form. The solid agent may take the form of a band (medband) or thin tape strip which lies between the teeth and the wire of the brace.

Such brace form of the dental device allows agents which are activated or enhanced by, for example, light, heat, electrical, stimulation to be provided to a subject's teeth and/or gums, while being closely and precisely coupled to the source of light, heat, electrical stimulation etc. It further allows the agents which transmit, for example, light, heat, electrical stimulation to be provide in intimate contact with the source of the functionality and a subject's teeth and/or gums.

Electrical Components

A dental device according to the present invention is provided with one or more electrical components, said components providing additional functionality.

LED

In one embodiment of the present invention, at least one component is a light emitting diode (LED). An LED of the present invention may be any suitable for inclusion in a wall of the trough or attachment to a brace. The provision of at least one LED in a device according to the invention enhances dental processes which require light such as curing, bleaching, and illumination. An LED has a long lifetime compared with bulbs presently used, therefore, a device of the present invention requires low maintenance. The power consumption of an LED is lower than that of a convention bulb, therefore, the power supply may also be miniturised and battery life extended. LEDs are capable of emitting light only, while emitting little or no heat, therefore, procedures which are enhanced only by light can be selectively activated, such as blue light curing, while procedures which are enhanced only be heat are not expedited. An LED provided in a device according to the invention allows light to be directly administered to the teeth and or gums, and may be used to activate substances contained in the trough or in a med-band (see below) such as bleaching agent, anti-bacterial agent, pain killer etc.

According to one embodiment of the present invention, an LED is capable of emitting light of a single wavelength or range of wavelengths. Examples of the spectral bands of light include, but are not limited to visible light, ultraviolet (UV) light, and infrared light.

For emitting visible light, an LED can be any, including but not limited to a coloured LED (red, orange, yellow, green, blue, indigo, violet etc), a white-light LED, an ultrabright LED. For coloured LEDs, the emitted wavelength or range of wavelengths are any of the visible spectrum, and are generally in the range 420 to 660 nm. For curing coloured light-curable dental materials, an LED may emit blue light (e.g. between 400 and 500 nm). The advantage of using an LED compared with a conventional halogen bulb is the narrow emission band of the former; if an initiator of polymerisation absorbs light outside a preferred band, the restoration may be compromised.

An LED according to the invention may be any capable of providing UV light. The emitted wavelength or range of wavelengths are any of the UV spectrum, and are generally within the range 370 to 410 nm.

An LED according to the invention may be any capable of providing IR light. The IR light may be in the near-infrared spectrum. The wavelength or range of wavelengths are generally in the range 750 to 1300 nm, 800 to 1200 nm, 900 to 1100 nm, 900 to 1000 nm, 750 to 1000 nm, or 1000 to 1300 nm.

According to another embodiment of the present invention, an LED is capable of providing heat. Heat may be provided by means of said LED emitting infrared radiation, preferably in the far infrared spectrum. Examples of the wavelengths include, but are not limited to 1400 to 14 000 nm, 1 400 to 10 000 nm, 1 400 to 8 000 nm, 1 400 to 7 000 nm, 1 400 to 6 000 nm, 1 400 to 5 000 nm, 1 400 to 4 000 nm, 1 400 to 3 000 nm, and 1 400 to 2 000 nm. The provision of at least one far-IR LED in a device according to the invention enhances and activates dental processes which require heat such as curing, bleaching and pain relief. A far-IR LED provided in a device according to the invention allows heat to be directly administered to the teeth and or gums, and may be used to activate and enhance the action of substances contained in the trough such as bleaching agent, anti-bacterial agent, pain killer etc. It may also be used without any agent, or in combination with a heat conducting material in the trough to provide therapeutic heat to the teeth and/or gums.

The number of LEDs in a device of the invention when present may be 1, 2, 3, 4, 5, 6, 7, 8, 9, 10, 11, 12, 14, 15, 16, 17, 18, 19, or 20, or more than 20.

Electroluminescent Device

In one embodiment of the present invention, at least one component is an electrolumiscent device (ELD). An known in the art, an ELD is similar to a laser in that photons are produced by the return of an excited substance to its ground state, but unlike lasers ELDs require much less energy to operate and do not produce coherent light. EL is also used in lamps and backlights. There are four steps commonly understood to produce electroluminescence in ELDs:

1. Electrons tunnel from electronic states at the insulator/phosphor interface;

2. Electrons are accelerated to ballistic energies by high fields in the phosphor;

3. The energetic electrons impact-ionize the luminescent center or create electron-hole pairs that lead to the activation of the luminescent center; and

4. The luminescent center relaxes toward the ground state and emits a photon.

All ELDs have the same basic structure as known by the skilled person. There usually at least six layers to the device. The first layer is a baseplate (usually a rigid insulator like glass), the second is a conductor, the third is an insulator, the fourth is a layer of phosphors, and the fifth is an insulator, and the sixth is another conductor.

ELDs are quite similar to capacitors except for the phosphor layer. An ELD can be thought of as a “lossy capacitor” in that it becomes electrically charged and then loses its energy in the form of light. The insulator layers are necessary to prevent arcing between the two conductive layers.

An alternating current (AC) is generally used to drive an ELD because the light generated by the current decays when a constant voltage is applied. There may be, however, ELDs that are DC driven.

ELDs are well known in the art, and understood to mean illumination devices characterised according to one or more of the features below:

comprising a (semiconducting) phosphor,

EL is produced by electrical excitation of a phosphor,

an ELD comprises a pair of electrodes and a phosphor layer, said electrodes capable of activating the phosphor, or

an ELD comprises an inverter.

The electrodes and phosphor assembly in an ELD which emit light can be arranged in a variety of configurations as known to the skilled person. For example, they can form a wire, a thin panel which can be a strip, tape, or any regular or irregular shape. They can be flexible or rigid.

An ELD of the present invention may be any suitable for inclusion in a wall of the trough. An ELD of the present invention may be any suitable for incorporation into a brace. The provision of at least one ELD in a device according to the invention enhances dental processes which require light such as curing, light sources or bulbs presently used, therefore, a device of the present invention requires low maintenance. An ELD provides light continuously and evenly along the length of the electrode thereby providing equal energy to the desired teeth, without hotspots (intense light) or blackspots (weak/no light). The power consumption of an ELD is lower than that of a convention light sources, therefore, the power supply may also be minaturised and battery life extended. ELDs are capable of emitting light only, while emitting little or no heat, therefore, procedures which are enhanced only by light can be selectively activated, such as blue light curing, while procedures which are enhanced only by heat are not expedited. An ELD provided in a device according to the invention allows light to be directly administered to the teeth and or gums, and may be used to activate substances contained in the trough or brace such as bleaching agent, anti-bacterial agent, pain killer etc.

According to one embodiment of the present invention, an ELDs is capable of emitting light of a single wavelength or range of wavelengths. Examples of the spectral bands of light include, but are not limited to visible light and ultraviolet (UV) light. The ELDs of the present invention are different from LEDs as is understood by the skilled person.

For emitting visible light, an ELD can be any, including but not limited to a coloured ELD (red, orange, yellow, green, blue, indigo, violet etc), a white-light ELD, an ultrabright ELD. For coloured ELD, the emitted wavelength or range of wavelengths are any of the visible spectrum, and are generally in the range 420 to 660 nm. For curing coloured light-curable dental materials, an ELD may emit blue light (e.g. between 400 and 500 nm). The advantage of using an ELD compared with a conventional halogen bulb is the narrow emission band of the former; if an initiator of polymerisation absorbs light outside a preferred band, the restoration may be compromised.

An ELD according to the invention may be any capable of providing UV light. The emitted wavelength or range of wavelengths are any of the UV spectrum, and are generally within the range 370 to 410 nm.

An ELD according to the invention may be any capable of providing IR light. The IR light may be in the near-infrared spectrum. The wavelength or range of wavelengths are generally in the range 750 to 1300 nm, 800 to 1200 nm, 900 to 1100 nm, 900 to 1000 nm, 750 to 1000 nm, or 1000 to 1300 nm.

The number of ELDs in a device of the invention when present may be 1, 2, 3, 4, 5, 6, 7, 8, 9, 10, 11, 12, 14, 15, 16, 17, 18, 19, or 20, or more than 20.

According to one aspect of the invention, an ELDs provides a continuous light. According to another aspect of the invention, an ELDs provides a pulsating light. Where the light is pulsating, the frequency of pulsation may be more than 1, 2, 3, 4, 5, 6, 7, 8, 9, 10, 11, 12, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58 59, 60 or more than 60 times per second. It may be 1 to 400, 1 to 300, 1 to 200, 1 to 150, 1 to 100, 1 to 50 or 1 to 25 times per second. The pulsation may be “on or off”, or may fade to “on or off” states.

ELDs generally provide light via one or more wires which illuminate across their entire length, and around 360 deg. A device of the present invention may be provided with one or more reflectors, positioned to reflect some or most of the light emitted away from the teeth, back towards one or more surfaces of the teeth. For example, where an ELD provides light towards the anterior surface of the teeth, one or more reflectors located towards the anterior of the device may reflect light back towards the teeth such that little or no EL can be seen through the anterior of the device.

According to one aspect of the invention, any of the inverter, controller and/or power supply are integrated into the device. According to one aspect of the invention, any of the inverter, controller and/or power supply are not integrated into the device. One or more ELD components may be located outside the trough. For example, the inverter, controller and/or power supply may be located so that they are outside the mouth when the device is inserted.

Means for Providing Heat

In another embodiment of the present invention, at least one component is a means for providing heat such as a heat transducer. A heat transducer is any device capable of transforming electrical current into heat. Examples of heat transducers include, but are not limited to, a wire heating element, a ceramic heating element, a silicon heating element, a semi-conductor heating element, a far IR light source, a heating strip, and a far-IR light emitting diode (LED) as mentioned above. The advantages of providing a heat transducer in a device of the invention are mentioned above in the context of a far-IR LED.

The number of heat transducers in a device of the invention when present may be 1, 2, 3, 4, 5, 6, 7, 8, 9, 10, 11, 12, 14, 15, 16, 17, 18, 19, or 20, or more than 20.

According to one embodiment of the present invention, a far-IR light source is capable of emitting far IR radiation at a single wavelength or at a range of wavelengths in the far-IR spectrum. Examples of the wavelengths include, but are not limited to Examples of the wavelengths include, but are not limited to 1400 to 14 000 nm, 1 400 to 10 000 nm, 1 400 to 8 000 nm, 1 400 to 7 000 nm, 1 400 to 6 000 nm, 1 400 to 5 000 nm, 1 400 to 4 000 nm, 1 400 to 3 000 nm, 1 400 to 2 000 nm.

The provision of at least one heat transducer in a device according to the invention enhances the effects of physical stimulation. The combination of two or more of physical stimulation, electrical stimulation, light and heat (e.g. physical stimulation and heat) further enhances treatments such as pain relief, cleaning, massage, healing, anti-bacterial-treatments, and plaque loosening. At least one heat transducer provided in a device according to the invention allows heat to be directly administered to the teeth and or gums. Heat may be used to activate and enhance the action of substances contained in the device such as cleaning agent, anti-bacterial agent, pain killer, plaque loosening agent etc. It may also be used without any agent, or in combination with a heat conducting material to provide therapeutic heat treatment to the teeth and/or gums.

Electrical Stimulation Means

In another embodiment of the present invention, at least one component is a stimulating means for delivering stimulating electrical current. Examples of stimulating means include electrodes, pads and associated circuitry. A stimulating means provided in a device according to the invention allows electrical stimulation to be directly administered to the teeth and/or gums, or may be used to activate and enhance the action of substances such as bleaching agent, cleaning agent, anti-bacterial agent, pain killer etc. It may also be used without a substance, or in combination with an electrical conducting material to provide therapeutic stimulation to the teeth and/or gums. For example, electrical stimulation may be applied to reduce pain, increase blood flow, enhance healing by providing Transcutaneous Electrical Nerve Stimulation (TENS). The pulses and intensity thereof for such relief are known to the skilled person.

It is a further aspect of the invention that a device of the present invention is provided with one or more connectors to allow a device of the present invention to connect to a TENS pulse providing unit.

The number of electrical stimulation means in a device of the invention when present may be 1, 2, 3, 4, 5, 6, 7, 8, 9, 10, 11, 12, 14, 15, 16, 17, 18, 19, or 20, or more than 20.

Means for Providing Physical Stimulation

In one embodiment of the present invention, a device is provided with one or more means for providing physical stimulation. According to an aspect at least one means for providing physical stimulation is a transducer that can convert electrical current into vibrational (translational) or rotational movement. Physical stimulation is within the ordinary meaning of the word. According to one aspect of the invention, physical stimulation implies the use of a mechanical force applied to a subject. Examples of such force include dragging, rubbing, abrasing, brushing, scraping, polishing, massaging, scrubbing, grinding, etc. depending on the degree of force necessary to achieve the desired effect. The frequency of such movement (or energy) may be suitable for, for example, rotating a set of bristles on the surface of teeth and gums. Alternatively, the frequency of such movement may be suitable for ultrasonic cleaning of teeth by an immersible ultrasonic transducer, for example. Alternatively, the frequency of such movement may be suitable for massaging teeth and gums by use of an ultrasonic motor, for example. The intensity of the movement may be adjusted according to the desired application. According to the invention any transducer producing physical stimulation is suitable for a dental device disclosed herein.

Ultrasonic Transducer

According to one embodiment of the present invention, at least one means for providing physical stimulation is an ultrasonic transducer.

An ultrasonic transducer according to the invention can be any type, including, but not limited to, air transducers, contact transducers, ultrasonic transmitters, piezoelectric transducers, piezo film transducers, and magnetostrictive transducers.

The number of ultrasonic transducers in a device of the invention when present may be 1, 2, 3, 4, 5, 6, 7, 8, 9, 10, 11, 12, 14, 15, 16, 17, 18, 19, or 20, or more than 20.

The frequency range of an ultrasonic transducer according to the invention is between 20 to 800 kHz, 20 and 700 kHz, 20 and 600 kHz, 20 and 500 kHz, 20 and 400 kHz, 20 and 300 kHz, 20 and 200 kHz, 20 and 150 kHz, 20 and 100 kHz, 20 and 50 kHz, 20 and 30 kHz, or 20 and 250 kHz.

An ultrasonic transducer provided in a device according to the invention allows ultrasonic stimulation to be directly administered to the teeth and/or gums, and may be used to activate and enhance the action of substances contained in the device such as, for example, cleaning agent, anti-bacterial agent, pain killer, massage gel etc. Ultrasonic stimulation may also be used without an active substance, or in combination with an ultrasound-conducting material to provide, for example, ultrasonic cleaning to the teeth and/or gums, increasing blood flow to the gums, loosening plaque on the teeth and below the gums, massage, healing, and stimulation of the tissues.

Ultrasonic Motor

According to one embodiment of the present invention, at least one means for providing physical stimulation is an ultrasonic motor.

An ultrasonic motor according to the invention can be any type, including but not limited to ultrasonic piezoelectric motors, and thin-disc piezoceramic ultrasonic motor transducers.

The number of ultrasonic motors in a device of the invention when present may be 1, 2, 3, 4, 5, 6, 7, 8, 9, 10, 11, 12, 14, 15, 16, 17, 18, 19, or 20, or more than 20.

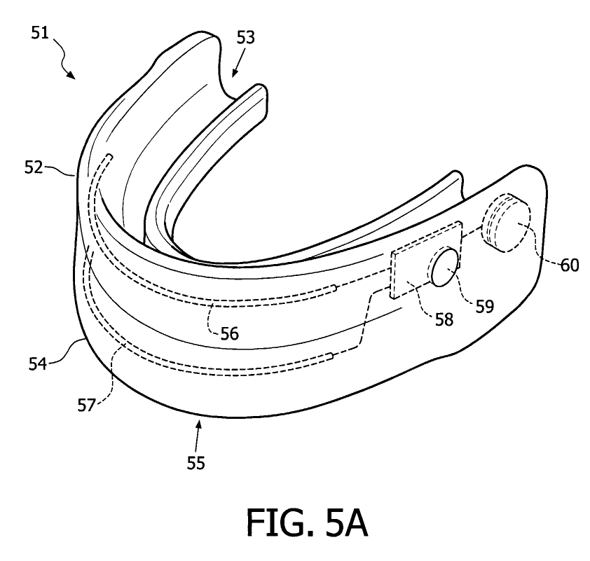

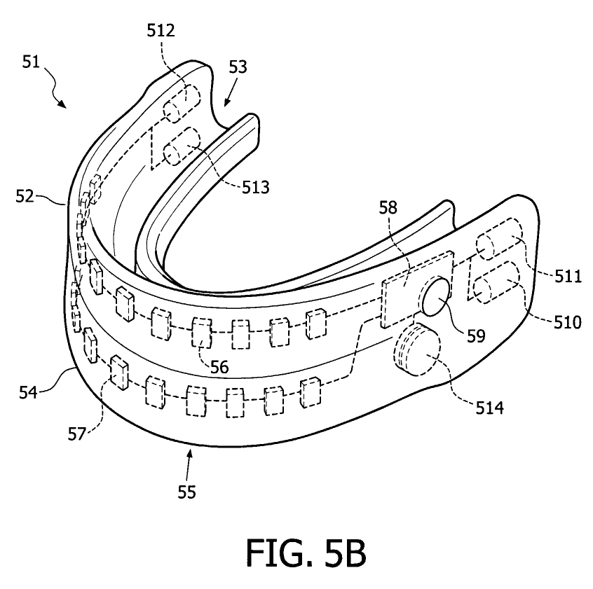

Such an ultrasonic motor provides a massaging to the teeth and/or gums which increases blood flow, loosens plaque and enhances healing. An ultrasonic motor may be positioned anywhere in the device suitable for conducting physical stimulation to the teeth and/or gums. For example, an ultrasonic motor may be positioned such that it vibrates at least a portion of a trough or brace as disclosed herein. For example, FIG. 5B depicts four ultrasonic motors located towards the ends of the dental device, two of which provide vibrations to each of the upper and lower trough.

Such an ultrasonic motor may conduct movement to one or more protrusions located on the device and described below. Said protrusions contact the teeth and/or gums, and are capable of abrasive cleaning and/or polishing thereof.

Magnetic Motor

According to one embodiment of the present invention, at least one means for providing physical stimulation is a magnetic motor. A magnetic motor is any which uses a magnet or magnetism to drive movement.

An magnetic motor according to the invention can be any type, including but not limited to permanent-magnet motors, AC motors.

The number of magnetic motors in a device of the invention when present may be 1, 2, 3, 4, 5, 6, 7, 8, 9, 10, 11, 12, 14, 15, 16, 17, 18, 19, or 20, or more than 20.

Such a magnetic motor provides a massaging to the teeth and/or gums which increases blood flow, loosens plaque and enhances healing. A magnetic motor may be positioned anywhere in the device suitable for conducting physical stimulation to the teeth and/or gums.

Such an magnetic motor may conduct movement to one or more protrusions located on the device and described below. Said protrusions contact the teeth and/or gums, and are capable of abrasive cleaning and/or polishing thereof.

Multi-Components

It is an aspect of the invention that a device comprises more than one of the same type of component. For example, a device may be disposed with a row of LED each of which emits blue light. It is another aspect of the invention that a device comprises more than one different types of component. For example, a device may be disposed with a row of UV-, blue-light LEDs, and electrodes. It is an aspect of the invention that a dental device comprises one or more means to provide physical stimulation. Said means may a number of ultrasonic motors, a number of ultrasonic transducers, a number of magnetic motors or a combination of both. Optionally, a dental device, may comprise one or more heat providing means. Said heat-providing means my be a number of far IR-LEDS, a number of heat transducers, or both. Such functionality may be provided simultaneously or during separate treatments.

Position of Electrical Components

According to one embodiment of the present invention, the electrical components are positioned such that functionality (e.g. light, heat, ultrasonic vibration) is directed towards the desired location. The positioning of components is known to the skilled person.

According to another embodiment of the present invention, at least one electrical component is positioned such that functionality is directed towards the anterior surface of said teeth and/or gums. This may be achieved, for example, by providing an electrical component on or in the inner anterior wall of the trough, or by incorporating or attaching an electrical component into a wire of a brace. It may also be achieved by providing an electrical component in a hollow between the anterior inner and outer walls of a trough.

According to another embodiment of the present invention, at least one electrical component is positioned such that functionality is directed towards the posterior surface of said teeth and/or gums. This may be achieved, for example, by providing an electrical component on or in the inner posterior wall of the trough, or by an electrical component into the support of a brace. It may also be achieved by providing an electrical component in a hollow between the posterior inner and outer trough walls.

According to another embodiment of the present invention, at least one electrical component is positioned such that functionality is directed towards to the top surface of said teeth and/or gums. This may be achieved, for example, by providing an electrical component on or in the inner base wall of the trough, or by in incorporating an electrical component into a portion of a brace which crosses the top surface of the teeth. It may also be achieved by providing an electrical component in a hollow between the base inner and outer trough walls.

According to another embodiment of the present invention, at least one electrical component is positioned such that functionality is directed towards the top surface of said teeth and/or gums located on the opposing dental arch. This may be achieved, for example, by providing an electrical component on or in the outer base wall of the trough. It may also be achieved by providing an electrical component in a hollow between the base inner and outer trough walls. It may also be achieved by incorporating an electrical component into a portion of a brace which crosses the top surface of the teeth. For example, dental device according to the present invention may be provided with a visible light LED or ELD positioned in the outer wall of the base of the trough, projecting light towards the teeth and gums on the opposing dental arch.

According to one aspect of the invention at least one electrical component may be disposed within the wall of the trough so that the functionality is provided through the material of the wall of the trough. According to another aspect of the invention at least part of an electrical component is exposed, so that functionality does not necessarily pass though the material of a wall of the trough. According to the latter aspect, at least part of a component is recessed, proud or flush with the surface of the trough.

It is an aspect of the invention that a dental device comprises electrical components arranged to that functionality is directed towards two or more of i) the anterior surface of the teeth and/or gums, ii) the posterior surface of said teeth and/or gums, iii) the top surface of said teeth and/or gums. By providing components so arranged, the top, front and/or back of a subject's teeth and/or gums may be treated by a single device.

According to another embodiment of the present invention, at least part of an electrical component is provided in a hollow between the inner and outer walls of a trough, so providing functionality to the top surface, anterior surface, and/or posterior surface of said teeth and/or gums, depending on how said component is positioned in said hollow. For example, a dental device according to the present invention may be provided with a row of visible light LEDs positioned in a hollow between the anterior inner and outer trough walls; they may project light through the material of the inner trough wall towards the anterior surface of the teeth and gums.

In one example, a dental device according to the present invention may be provided with one or more ultrasonic motors, disposed in separate hollows towards the ends of a trough (see for example, FIG. 6D which depicts a single ultrasonic motor, 73). They provide vibration to one or more the surfaces of the teeth and/or gums of a dental arch.

In another example, a dental device according to the present invention may be further provided with a row of far-IR LEDs positioned in a hollow between the anterior inner and outer trough walls; they may project IR heat through the material of the inner trough wall towards the anterior surface of the teeth and gums.

The number of electrical components (e.g. physical stimulation providing means) in a dental device is at least one. The number of electrical components may be sufficient to provide treatment in the regions required. The number of electrical components may be sufficient to provide functionality of an intensity required. The number may be sufficient to provide sufficient coverage of the dental arch.

Regulating Means

Another embodiment of the present invention is a device further comprising one or more means to regulate said electrical components. Such a means includes a controller comprising circuitry. A controller may regulate each component, or may regulate two or more components as part of the same circuit. In one aspect of the invention, the means may regulate the intensity of the functionality e.g. the brightness of the LED, the intensity of an ELD, the heat output from the heat transducer, the intensity of electrical stimulation, the heat output from a ceramic heating element, the intensity of the ultrasound from an ultrasound transducer, the intensity of heat from an IR LED etc. In another aspect of the invention, the means may provide a programmed pulsing of an electrical component e.g. a flashing of an LED or IR LED, a sinusoidal or saw-tooth output of the electrical stimulation means or ultrasonic transducer, the pulsating the ELD etc. In another aspect of the invention, the means may provide an electrical component with timed on and off periods. Such timing would provide a fixed treatment time, a variable treatment time, a progressively shorter treatment time or a treatment regiment prescribed by a dental practitioner or manufacturer. Such means may be programmable or “hard-wired”. In another aspect of the invention, the regulating means provides pulses suitable for TENS pain relief.

Controlling the functionality of one or more components allows the treatment to be precisely modulated according to the needs of the subject. It further allows the treatment to be compatible with any substance or concentration thereof placed in the trough or in contact with the brace. It further allows a single device to have multiple functionality, said functions being activated depending on the treatment required (e.g. blue/UV light for curing, heat for pain relief, the necessary components therefor being present in the same device; heat and vibration for pain relief, vibration only for plaque removal, the necessary components therefor being present in the same device).

Programming Device

Another embodiment of the present invention is a programming device comprising a means for transmitting regulating information to the controller. The means for transmitting information to the controller may be any, including, but not limited to one, or more electrical contacts, electromagnetic radiation, optical link. A programming device may optionally comprise one or more of the following features: a supporting means for the dental device, a user input means, a display, a computer interface. It is a further aspect of the invention that said programming device comprises one or more of the features of the charging device mentioned below.

Audible/Vibration Indication

Another embodiment of the present invention a dental device further comprising a sound transducer or a vibration transducer which indicates to a subject by sound or by vibration a stage of the treatment, while the subject is wearing said dental device. A sound may be any audible signal, and includes but is not limited to a buzz, one or more tones, clicks, or speech or music. A vibration may be any that can be felt by a dental arch. A device may signal by means of said transducer, for example, the start of treatment, end of treatment, number of minutes until the end of treatment, an error, a change in the program, battery life etc. When speech is used to indicate an event, sound may be transmitted to the ear via the bones of the jaw.

Visual Indicator

Another embodiment of the present invention is a device further comprising at least one visual indicating means. An indicating means may be used to provide information such as, for example, battery life, type of program, programming information, program intensity, and any other aspect of the treatment. Examples of indicating means include, but are not limited to LEDs, LCDs. The visual indicating may be one or more LEDs and/or ELDs which are components disposed in the device.

Power Source

Another embodiment of the present invention is a device further comprising one or more power sources. A power source may be a battery, a rechargeable cell or any other self-contained means for providing electrical current. A battery may be any, such as, for example, a button battery. A rechargeable cell may be recharged through a mains powered adapter, a car-battery powered adapter, a solar charging means or any other suitable source of electrical current.

According to another embodiment of the invention, the device is powered by an external power source. According to an aspect of the invention, a device is provided with a means for connection to an external power source. Such means includes, for example, an electrical cable or a connection socket. The external power source may be, for example, an external battery pack, mains power, solar power, wind-up (“clockwork”) generator. Where main power is used, an transformer may reduce the voltage if necessary. It is as aspect of the invention that the device takes power from a source already available in a bathroom, such as, for example, from an electric tooth brush. The device may be equipped with means to draw power from an electric tooth brush recharger e.g. via a device compatible with the charging base of a tooth brush, such as a conductance coil. Alternatively, the device may be equipped with means to draw power from an electric tooth brush e.g. from the head portion of an ultrasonic electric toothbrush.

It is an aspect of the invention that a device comprises at least one power source which is removable. For example, a button battery might be removed once it has expired, and be replaced with a fresh battery. In another example a device might be supplied with a battery present not as part of the device, for insertion into a device upon use. In another aspect of the invention a device has a means for holding a power source, such that said source can be inserted and removed by a user of the device. Said means may comprise, for example, a battery compartment comprising one or more electrical contacts. Said means may further comprise one or more of a shaped recess complementary in shape to at least part of a battery, a removable compartment cover, a battery clip, a battery cartridge. Any means for holding a power source so that said source changable is suitable according to the present invention.

It is another aspect of the invention that a device comprises at least one sealed power source which is designed to last for a fixed number of treatments. Once the treatment has finished or battery life has expired, the device and battery therein are disposed of.

Charging Device

One embodiment of the present invention is a charging device comprising a means for providing charging current to a rechargeable cell of the dental device. The charging current may be provided by any means, including electrical contact, conductance, electromagnetic radiation. A charging device may optionally comprise one or more of the following features: a supporting means for the dental device, a user input means, a display, a computer interface. It is a further aspect of the invention that said charging device comprises one or more of the features of the programming device mentioned above.

Switch

Another embodiment of the present invention is a device further comprising at least one switching means. A switching means may be used to allow control of the device. For example to turn the device on or off, to select a program, to select an intensity, to program the regulator.

Reading Means

Another embodiment of the present invention is a device further comprising at least one reading means for reading information provided by an insert. Such inserts are described in more detail below. Said reading means may read information regarding the insert such as the agents held therein, the concentration of agents, the appropriate functionality (e.g. heat, light, ultrasound), the intensity of functionality required, the duration of functionality required. Such as reading means may be any, including but not limited to electrical contacts, optical reader, electromagnetic receiver.

The one or more of the electrical components, controller, sound and switch may be co-operatively connected, wired and configured in a device using methods and technologies known to the skilled person.

Double-Trough Device

Another embodiment of the present invention is a dental device further comprising a second device as disclosed herein, said second device arranged so that the teeth and/or gums of both the upper and lower arches are each immersable in a trough.

The upper and lower trough are provided with the functionality as disclosed herein.

Such a double-troughed dental device allows both the upper and lower arches to be treated simultaneously, so halving the time for the treatment of both arches.

Another embodiment of the present invention is a double-troughed dental device described above further comprising a means for the passage of air between the posterior and anterior of said dental device. Such a means may be any, and includes, but is not limited to, one or more openings between the upper and lower troughs, one or more ducts connecting the posterior of the dental device to its anterior end. Said means allows a subject to breathe comfortably while receiving treatment from the device.

Another embodiment of the present invention is a double-troughed dental device described above wherein each trough is provide with its own controller, battery compartment and/or switch. Another embodiment of the present invention is a double-troughed dental device described above wherein the device is provided a single controller, battery compartment and/or switch.

Colours and Styles

One embodiment of the present invention is a dental device provided in a colour, style and/or material to enable identification of a personal dental device. For example, a device may be provided in a variety of opaque bright colours, translucent materials, patterned polymers, composites, designer styles, custom painted, photographically etched, embossed, engraved etc. styles. Such identification may be required, for example, in families wherein each family member is in possession of a dental device of the present invention.

Another embodiment of the present invention is a dental device disclosed herein constructed in part from a translucent material which allows light from one or more LED or ELD electrical components to be viewed from the open mouth of a subject. Children, for example, may be reluctant to wear a dental device for any period of time, due to the often unsightly appearance of dental devices. Therefore, it is an aspect of the invention to provide a dental device disposed with at least one visible light LED and/or ELD which may be viewed from the open mouth of a subject, e.g through the translucent material of a trough. A further aspect of the invention is a device wherein two or more visible light LEDs illuminate in a pattern, such as, for example, chasing lights, flashing light etc. A further aspect of the invention is a device wherein at least two visible light LEDs are different colours. For example, a device may have a row of LEDs, each a different colour, and which flash in a predetermined pattern, or in time to speech or music. It is an aspect of the invention that two or more visible light LEDs are two or more visible light ELD or at least one visible light LED and at least one visible light ELD in the above embodiments.

Such an arrangement of LEDs and/or ELDs encourages children, for example, to wear a dental device while receiving treatment—the LEDs/ELDs providing a distraction while simultaneously providing treatment to the teeth and/or gums of the dental arch.

Insert

Another embodiment of the present invention is an insert comprising one or more agents, for receiving the functionality of at least one electrical component of a dental device as disclosed herein.

Another embodiment of the present invention is an insert comprising one or more agents and a means for reciprocating with the receiving means of the dental device in order to locate correctly and optionally secure the insert into a receiving means of the dental device.

The functionality of the dental device (e.g. visible light, UV light, IR-light, heat, electrical, physical stimulation) interacts with the insert to activate the agents, to enhance their effect or to enhance the effect of the functionality.

An insert of the present invention allows agents which are activated or enhanced by, for example, light, heat, physical or electrical stimulation to be provided to a subject's teeth and/or gums, while being closely and precisely coupled to the source of light, heat, electrical stimulation. Thus, treatment can be exquisitely controlled and adjusted according to the needs of the subject.

An insert of the present invention may also allow the agents which transmit, for example, light, heat, electrical stimulation to be in intimate contact with the source of the light, heat, electrical, physical stimulation and a subject's teeth and/or gums. Good conductance so achieved allows efficient conductance of the functionality to the teeth and/or gums and further means that treatment can be controlled and adjusted according to the needs of the subject.

Specific Agents of the Insert

According to one embodiment of the present invention, an insert comprises one or more agents which are bleaching agents suitable for whitening teeth. Examples of bleaching agents are known in the art and include but are not limited to oxygen radical generating agent such as metal ion free peroxides, organic peroxides, metal ion containing peroxides, metal chlorites, perborates, percarbonates, peroxyacids and combinations thereof. Specific, non-limiting examples of bleaching agents suitable for use with the invention are redox agents such as monopersulfate, Oxone, ammonium persulfate, potassium persulfate, potassium monopersulfate, potassium peroxymonosulfate, potassium bisulfate, potassium sulfate, and potassium peroxidisulfate. Additional specific, non-limiting examples of bleaching agents suitable for use with the device of the invention are the peroxide class of bleaching agents such as hydrogen peroxide, calcium peroxide, carbamide peroxide, urea peroxide, sodium percarbonate, sodium perborate, calcium hydroxide, calcium chlorite, barium chlorite, magnesium chlorite, lithium chlorite, potassium chlorate, hypochlorite, chlorine dioxide, magnesium carbonate and perhydrol urea and mixtures and derivatives thereof. In an embodiment of the present invention the bleaching agent used is hydrogen peroxide.

According to another embodiment of the present invention, an insert comprises one or more cleaning agents, which are suitable for cleaning with teeth and gums. Examples of cleaning agents include baking soda, tooth paste, and tooth gel.

According to another embodiment of the present invention, an insert comprises one or more pain-relief agents, which are suitable for relieving pain associated with teeth, gums and nerves. Examples of pain-relieving agents include but are not limited to aspirin, ibuprofen, brufen.

According to another embodiment of the present invention, an insert comprises one or more anti-bacterial agents, which are suitable for treating bacterial associated with the teeth gums and nerves. Examples of anti-bacterial agents include but are not limited to penicillin, erythromycin, chlroamphenicol, tetracycline.

According to another embodiment of the present invention, an insert comprises one or more anti-bad-breath agents, which are suitable for treating bad breath (e.g. halitosis). Examples of anti-bad breath agents include but are not limited to cetylpyridinium chloride (CPC), zinc chloride, and chlorhexidine.

According to another embodiment of the present invention, an insert comprises one or more healing agents, which are suitable for treating wounds, operational openings, swellings or lesions caused by dental braces, dental implants etc. Examples of healing agents include but are not limited to vitamin E, aloe vera.

According to another embodiment of the present invention, an insert comprises one or more plaque-removing agents. Examples of plaque removing agents include, but are not limited to triclosan, chlorhexidine gluconate, cetylpyridinium chloride, sanguinarine, stannous fluoride, octenidine, bispyridine, and delmopinol.

According to another embodiment of the present invention, an insert comprises tooth polish.

According to another embodiment of the present invention, an insert comprises a formulation, suitable for conducting a functionality to the teeth and/or gums. Examples include formulations for conducting heat, physical stimulation (e.g. vibration), light, electrical stimulation etc. Such a formulation enable the efficient and effective transfer of heat, light, electrical, physical stimulation from the trough or brace to the teeth and/or gums.

In another embodiment of the invention, an insert may comprise a combination of agents and/or formulations which permit multiple treatments, enhanced by multiple functionalities. For example, an insert may comprise light-activated pain relief agents, heat-enhanced menthol agents and agents for conducting electrical stimulation; a suitably configured device may simultaneously or sequentially activate the pain relief agents, enhance the methanol agents and provide TENS therapy. In another example, an insert may comprise heat-enhanced menthol agents and agents for conducting ultrasonic vibration; a suitably configured device may simultaneously or sequentially enhance the methanol agents and provide message therapy. Such a multiple therapy delivered by a single unit provide enhanced treatment for the subject in a conveniently-delivered form.

Cassette

According to another embodiment of the invention, an insert comprises a cassette which holds one or more agents formulated in a suitable carrier. According to one aspect of the invention, a cassette is at least partially trough-shaped and is suitable for insertion into at least part of the trough of the device. Said cassette permits the immersion of teeth and/or gums of a dental arch therein. Said cassette permits functionality provided by the trough (e.g. light, heat, physical stimulation etc) to be conveyed to the agents held within the cassette. The conveyance of functionality maybe provided, for example,

by one or more holes in the wall of the cassette which correspond with the position of the electrical components,

by using a material for the cassette which allows the functionality to pass therethrough (e.g. a clear polymer for the transmission of visible light, a heat conducting substance for the transmission of hear)

by one or more windows in the wall of the cassette which correspond with the position of the electrical components, said windows constructed from a material which allows the functionality to pass therethrough.

According to one aspect of the invention, said cassette is made from a solid, polymeric material.

According to one aspect of the invention, said cassette is provided with a means for indicating the contents held therein which can be read by a reading means in the trough. For example, a cassette provided with bleaching agents formulated in a suitable carrier, may provide an indication of one or more of the following: the bleaching agents held, the concentration of bleaching agents, the appropriate functionality (e.g. heat, light, physical stimulation) required to interact with the agents, the intensity of functionality required, the duration of functionality required. Thus, a cassette provided with an indicating means may be inserted into a dental device, and said device will automatically select the treatment program for use with the contents of the cassette. If the device is not equipped with the appropriate functionalty, it may indicate so through, for example, an audible signal, and not proceed with the treatment. Such an indicating on the cassette means may be, for example, light readable, electronically readable (e.g. a chip), physically readable (e.g. one or more grooves), electromagnetically readable etc.

According to another aspect of the invention, said cassette is provided with a means for reciprocating with the receiving means of the dental device in order to locate correctly and optionally secure the cassette into the dental device. This means may interact with any of the trough base, ridges, grooves, holes, lugs etc. of the receiving of the dental device means mentioned above.

Suitable formulations of the agents for a cassette are any which provide the appropriate viscosity, stickiness, friction, and are compatible with the cassette, teeth/gums and trough. Considerations include the ability of the formulation to enter crevices of the teeth and gums, ability to be contained within the cassette without undue spillage, ability to conduct functionality (e.g. light, heat, physical stimulation) to the agents and the teeth, ability to remain on a dental arch for a period of time, compatibility with the agents. Suitable formulations of agents and carrier are known to the person skilled in the art.

A cassette facilitates the cleaning of the trough, since the agent is contained within the cassette. This allows a trough to be constructed from lightweight and less robust materials which are not required to withstand abrasive cleaning. After use, for example, a trough may be left to soak. The cassette may be refillable or disposable. The refillable option allows a cost-saving for the subject, while the disposable option provides convenience.

Stick Gel

According to one embodiment of the present invention, an insert is formulated as a stick gel for insertion into a dental device disclosed herein.

Suitable formulations of the agents for a stick gel are any which provide the appropriate viscosity, stickiness, friction, and are compatible with the teeth/gums and trough. Considerations include the ability to enter crevices of the teeth and gums, ability to be contained within the trough without undue spillage, ability to conduct functionality (e.g. light, heat, electrical, physical stimulation) to the agents and the teeth, ability to remain on a dental arch for a period of time, compatibility with the agents, ability to maintain a form which can be inserted and removed from the trough. Suitable formulations of agents and carrier are known to the person skilled in the art.

In an embodiment, the stick gel can be formulated in a high viscosity aqueous or nonaqueous gel. Non-limiting examples of gelling agents useful in the present invention include carboxymethyl cellulose, carboxypolymethylene, carboxypropyl cellulose, poloxamer, carrageenan, silica and natural gums such as gum karaya, xanthan gum, Guar gum, gum arabic and mixtures thereof. For example, the amount of gelling agent to form the gel composition can be from 0.1% to 15%, preferably from 1% to 10% by weight of the substance. Humectants may be added when formulating the bleaching agent in a gel. Non limiting examples of suitable humectants useful in the present invention include glycerin, sorbitol, propylene glycol, polyethylene glycol and other food grade polyhydric alcohols. Typically humectants can be present in an amount of from 10% to 95% by weight of substance. A pH adjusting agent may be added to optimize stability of the gel and make it safe for the hard and soft tissues in the oral cavity. Non-limiting examples of suitable pH adjusting agents include sodium hydroxide, sodium bicarbonate, sodium carbonate, hydrochloric acid, phosphoric acid, citric acid and combinations thereof.

According to one aspect of the invention a stick gel is a straight tube-shape having sufficient flexibility be bent for insertion in a trough.

According to one aspect of the invention a stick gel is essentially tubular, its shape complementing at least part of the receiving portion of the trough.

Gel Strips

According to one embodiment of the present invention, an insert is formulated as a band of gel (gel strip, or ‘med band’) for insertion into a groove or other receiving means of the trough or dental brace. According to one embodiment of the present invention, an insert is formulated as a thin band of gel (‘med band’) for use with a dental brace, which lies between the teeth and the wire of the brace. Such a band allows the treatment of a specific part of the dental arch with agent, such as, for example, the front teeth only.

Suitable formulations of the agents for a gel strip are any which provide the appropriate viscosity, stickiness, friction, and are compatible with the teeth/gums and trough. Considerations include the ability to contact the crevices of the teeth and gums, ability to be stay in contact with the teeth, ability to conduct functionality (e.g. light, heat, electrical, physical stimulation) to the agents and the teeth or gums, ability to remain on a dental arch for a period of time, compatibility with the agents, ability to maintain a form which can be inserted and removed from the trough or brace. Suitable formulations of agents and carrier are known to the person skilled in the art.

According to one aspect of the invention a gel strip is a straight strip of gel having sufficient flexibility be bent for insertion in a receiving means in the device.

According to one aspect of the invention a gel strip is a straight strip of gel suitable for reversibly adhering to the teeth. Such embodiment is useful when the device is brace.

According to one aspect of the invention a gel strip is a straight strip of gel, its shape complementing at least part of the receiving means of the trough. According to one aspect of the invention a gel strip is a straight strip of gel, its shape complementing at least part of the receiving means of the brace. According to one aspect of the invention a gel strip is a straight strip of gel, suitable for attachment to the teeth and cooperation with a brace of the invention.

It is an aspect of the invention that the a gel strip include is formulated using the same gelling agents and additives as used in the stick gel.

Packaging

The inserts according to the present invention, may be packaged as a plurality of inserts. Such a package provides a course of treatment wherein the number of inserts indicates the length of the treatment. For example, a teeth whitening course might be packaged to contain between 1 and 10 inserts. Alternatively, an insert might be singly packaged.

Types of packaging for the inserts of the invention are any and include, foil pouches, blister packs, foil-sealed trays, etc.

Treatments

Home Teeth Bleaching

One embodiment of the present invention is a dental device as disclosed herein for use in treating teeth and/or gums.

Another embodiment of the present invention is a use of dental device as disclosed herein for treating teeth and/or gums.

Examples of treatments include, but are not limited to bleaching of teeth, pain relief, treatment of bacterial infections, treatment of bad breath, healing, loosening plaque.

Another embodiment of the present invention is a method for treating teeth and/or gums comprising the step of applying a dental device as disclosed herein to either or both dental arches. Another embodiment of the present invention is a method for treating teeth and/or gums further comprising a step of placing an insert as disclosed herein into said dental device.

According to one embodiment, a device may be programmed to treat the gums and/or teeth for a fixed period of time (e.g. 2 to 30 minutes), after which time, an audible signal is emitted indicating the end of the treatment. The device may be used in this way daily, for example, for a number of prescribed days, or until the batteries run out.

Home Teeth Treatments

One embodiment of the present invention is a dental device as disclosed herein for use in treating teeth and/or gums.

Another embodiment of the present invention is a use of dental device as disclosed herein for home treatment.

Examples of treatments include, but are not limited to cleaning of teeth and gums, pain, bacterial infections, bad breath, healing, loosening plaque.

Another embodiment of the present invention is a method for treating teeth and/or gums comprising the step of applying a dental device as disclosed herein to either or both dental arches. Another embodiment of the present invention is a method for treating teeth and/or gums further comprising a step of placing an insert as disclosed herein into said dental device. Another embodiment of the present invention is a method for treating teeth and/or gums further comprising a step of placing toothpaste into a trough of a dental device as disclosed herein.

According to one embodiment, a device may be programmed to treat the gums and/or teeth for a fixed period of time (e.g. 2 to 30 minutes), after which time, an audible signal is emitted indicating the end of the treatment. The device may be used in this way daily, for example, for a number of prescribed days, or until the batteries run out.

Dental Practice Treatment and Continued Home Treatment

Another embodiment of the present invention is a method for treating the teeth and/or gums teeth of a subject comprising:

(A) the use of a dental device and insert on a subject as disclosed herein by a dental practitioner, wherein the concentration of agent is suitable for supervision by said practitioner, and

(B) the subsequent application and use of said dental device and insert by a non-dental practitioner, wherein the concentration of bleaching agent in the range not requiring supervision by said practitioner.

Thus, a subject may visit a dental practitioner for one or more treatments, wherein a high concentration of agent is used, suitable for use by a dental professional. Subsequent treatments may be performed at home, using less concentrated amounts of agents, by the non-practitioner, preferably the subject. The dental device may be the same device throughout the treatment. The practitioner may provide the subject with instructions on how to use the device, may program the device for the course of treatment, and/or may select the most appropriate concentration of bleaching agent. The method provides an advantage that the subject receives professional advice and treatment, said treatment being conveniently continued away from the dental surgery.

Whitening Teeth

One embodiment of the present invention is a dental device as disclosed herein for use in whitening teeth.

Another embodiment of the present invention is a use of dental device as disclosed herein for whitening.

Another embodiment of the present invention is a method for whitening teeth comprising the step of applying a dental device as disclosed herein to either or both dental arches.

In one embodiment, a dental device is configured with the electrical components which activate or enhance a bleaching agent. For example, for use with an insert comprising hydrogen peroxide, at least one component is an LED which provides light.

Curing

One embodiment of the present invention is a dental device as disclosed herein for use in curing restorative dental materials.

Another embodiment of the present invention is a use of dental device as disclosed herein for curing restorative dental materials.

Another embodiment of the present invention is a method for curing restorative dental materials comprising the step of applying a dental device as disclosed herein to either or both dental arches.

For curing, a dental device is configured with the electrical components compatible with the restorative material.

Pain Relief

One embodiment of the present invention is a dental device as disclosed herein for use in relieving pain.

Another embodiment of the present invention is a use of dental device as disclosed herein for relieving pain.

Another embodiment of the present invention is a method for relieving pain comprising the step of applying a dental device as disclosed herein to either or both dental arches.

In one embodiment, a dental device is configured with the electrical components which activate or enhance a pain-relieving agent. For example, for use with an insert comprising ibuprofen, at least one component is a heat transducer which provides heat. In another example, it is configured for use with an insert comprising ibuprofen, a dental device is provided with an ultrasonic motor and a plurality of far-IR LED.

In another embodiment a dental device is configured with the electrical components which act directly on the teeth or gums to provide pain relief. For example, the dental device may deliver electrical stimulation to the gums or teeth, in which case the component is a stimulating means. In another example, the dental device may deliver physical stimulation and/or heat directly to the gums and/or teeth, optionally with the use of a ultrasonic/heat conducting agent.

It is an aspect of the invention that the device is configured to provide TENS (Transcutaneous Electrical Nerve Stimulation) to the gums or teeth for pain relief. In another embodiment, the dental device may deliver heat to the gums or teeth, in which case, at least one component is a means for providing heat stimulation.

It is an embodiment of the invention that a device is provided with a combination or one or more of the above components to provide a multiple pain relief therapy with or without agent.

Bacterial Infections

One embodiment of the present invention is a dental device as disclosed herein for use in treating bacterial infections.

Another embodiment of the present invention is a use of dental device as disclosed herein for treating bacterial infections.

Another embodiment of the present invention is a method for treating bacterial infections comprising the step of applying a dental device as disclosed herein to either or both dental arches.

In one embodiment, a dental device is configured with the electrical components which activate or enhance an anti-bacterial agent. For example, for use with an insert comprising chloramphenicol, at least one component is a heat transducer which provides heat. In another example, the device is configured for use with an insert comprising an antibacterial agent chloramphenicol, a dental device is provided with an ultrasonic transducer.

Bad Breath

One embodiment of the present invention is a dental device as disclosed herein for use in treating bad breath.

Another embodiment of the present invention is a use of dental device as disclosed herein for treating bad breath.

Another embodiment of the present invention is a method for treating bad breath comprising the step of applying a dental device as disclosed herein to either or both dental arches.

In one embodiment, a dental device is configured with the electrical components which activate or enhance an anti-bad-breath agent. For example, for use with an insert comprising cetylpyridinium chloride, at least one component is a heat transducer which provides heat. In another example, a device is configured for use with an insert comprising cetylpyridinium chloride, a dental device is provided with an ultrasonic transducer.

Enhanced Healing

One embodiment of the present invention is a dental device as disclosed herein for use in enhancing healing.

Another embodiment of the present invention is a use of dental device as disclosed herein for enhancing healing.

Another embodiment of the present invention is a method for enhancing healing comprising the step of applying a dental device as disclosed herein to either or both dental arches.

In one embodiment, a dental device is configured with the electrical components which stimulate blood flow. For example, at least one component which is an electrical stimulation means, a physical stimulation means, a means for providing hest stimulation. By stimulating blood and optionally providing heat, healing times are greatly reduced. This may benefit the recovery of a subject after dental procedures such as, for example, tooth extraction or any procedure which causes lesions. It may further assist in the control of discomfort associated with wearing orthodontic braces that need adjusting, and with post dental implants. The treatment may be combined with the use of an insert comprising, for example, any of vitamin E, aloe vera, heat conducting formulation, pain-relieving agent etc.

Loosening Plaque

One embodiment of the present invention is a dental device as disclosed herein for use in loosening plaque.

Another embodiment of the present invention is a use of dental device as disclosed herein for loosening plaque. Another embodiment of the present invention is a method for loosening plaque comprising the step of applying a dental device as disclosed herein to either or both dental arches.

In one embodiment, a dental device is provided with physical stimulation-providing means and optionally heat-providing means. In another embodiment, a dental device is provided with physical stimulation-providing means and one or more other electrical components. By physically stimulating the gums and/or teeth, plaque is removed above and below the gum line.

In one embodiment, a dental device is configured with physical stimulation-providing means and optionally heat-providing means which activate or enhance a plaque loosening agent. In another embodiment, a dental device is configured with physical stimulation-providing means and one or more other electrical components which activate or enhance a plaque loosening agent. For example, for use with an insert comprising triclosan, a dental device is provided with an ultrasonic transducer.

Cleaning Protrusions

Another embodiment of the present invention is a device or insert disclosed herein further comprising one or more protrusions which contact the teeth and/or gums, said protrusions capable of abrasive cleaning, massaging and/or polishing teeth and/or gums. The protrusions may be one or more bristles, moulded protrusions, rubber beading, abrasive pad, polishing pad etc. Said abrasion or polishing may be achieved by movement of said protrusions such as, for example, vibrational, rotational, lateral movement etc. Said movements may be provided by one or more physical stimulation-providing means in said dental device, such as, for example, an ultrasonic motor, ultrasonic transducer, a magnetic motor, an AC motor etc.

Where the protrusions are provided in a dental device, they may be located in a wall of the trough, and arranged so as to contact any of the anterior, posterior or top surfaces of the teeth and/or gums, or a combination thereof. For example, to clean the front teeth, a set of bristles may be provided in the anterior inner wall of a trough To enhance the treatment provided by the protrusions, a cleaning agent such as toothpaste, or tooth polish may be added to a trough.

Where the protrusions are provided in an insert, they may be located and arranged so as to contact any of the anterior, posterior or top surfaces of the teeth and/or gums, or a combination thereof. The protrusions may be provided on a wall of a cassette or backing strip of a med band mentioned herein, or on the wall of an insert.

Dental Illumination

One embodiment of the present invention is a dental device as disclosed herein for use in illuminating the teeth and/or gums of the oral cavity during dental procedures.

Another embodiment of the present invention is a use of dental device as disclosed herein for illuminating the teeth and/or gums of the oral cavity during dental procedures.

Another embodiment of the present invention is a method for illuminating the teeth and/or gums of the oral cavity during dental procedures comprising the step of applying a dental device as disclosed herein to either dental arch.

In one embodiment, a dental device is provided with at least one visible light LED or ELD positioned on the device, such that light is projected therefrom onto the opposing dental arch. By illuminating the teeth and gums so, enables dental practitioner to acquire a clear view of the teeth and gums with a minimum of shadowing, and frees both hands for operational procedures. According to one aspect of the invention, this may be achieved, by providing one or more light-emitting LEDs or ELD on or in the outer base wall of the trough. It may also be achieved by providing an electrical component in a hollow between the base inner and outer trough walls. It may also be achieved by incorporating an ELD or LED into a portion of a brace which crosses the top surface of the teeth.

According to one aspect of the invention, a device further comprises one or more lenses for focusing light emitted by an LED or ELD. The appropriate positioning and lenses suitable therefor are known to the skilled person. One or more lenses in dental device allows light to be focused intensely on a particular area, or allows light to be diffused across a wide area, so enabling a dental professional to perform dental procedures with greater ease. It is a further aspect of the invention that a dental device comprises a means for adjusting the focus of one or more lenses.

Kit

Another embodiment of the present invention is a kit comprising a dental device as disclosed herein and one or more inserts as disclosed herein.

According to one aspect of the invention, the kit provides one or more inserts which comprise a higher concentration of bleaching or cleaning agent suitable for use by a dental practitioner, and one or more inserts which comprise a lower concentration of bleaching or cleaning agent, suitable for home use. The dental device of the kit is provide with one or more electrical components suitable for enhancing or stimulating the effect of said agents. The kit is intended for use in the first instance by a dental practitioner for whitening teeth: The inserts comprising a higher concentration of agents are intended for use by the practitioner on the subject, and the inserts comprising a lower concentration of agents are intended for use by non-practitioner, for example by the subject.

According to another aspect of the invention, the kit provides one or more inserts which comprise a concentration of bleaching agent suitable for home teeth bleaching. The dental device of the kit is provide with one or more electrical components suitable for enhancing or stimulating the effect of the bleaching agents. The kit is intended for use by a non-practitioner for self-whitening of a subject's teeth.

According to another aspect of the invention, the kit provides one or more inserts which comprise a concentration of cleaning agent suitable for home teeth bleaching. The dental device of the kit is provide with one or more electrical components (e.g. physical stimulation providing means) suitable for enhancing or stimulating the effect of the cleaning agents. The kit is intended for use by a non-practitioner for self-whitening of a subject's teeth.

According to another aspect of the invention, the kit provides one or more inserts which comprise one or more anti-bad breath agents suitable for treatment of bad breath and a dental device provided with one or more electrical components suitable for enhancing or stimulating the effect of the anti-bad breath agent (s). One aspect of the invention is a kit provided with one or more inserts in which anti-bad breath agent is at a concentration suitable for use in a dental surgery or suitable for use at home. Another aspect of the invention is a kit provided with one or more inserts in which anti-bad breath agent is at a concentration suitable for use in a dental surgery and one or more inserts in which a concentration of anti-bad breath agent is suitable for continued use at home.

According to another aspect of the invention, the kit provides one or more inserts which comprise one or more anti-bacterial agents suitable for treatment of bacterial infections and a dental device provided with one or more electrical components suitable for enhancing or stimulating the effect of the anti-bacterial agent(s). One aspect of the invention is a kit provided with one or more inserts in which antibacterial agent is at a concentration suitable for use in a dental surgery or suitable for use at home. Another aspect of the invention is a kit provided with one or more inserts in which antibacterial agent is at a concentration suitable for use in a dental surgery and one or more inserts in which a concentration of antibacterial agent is suitable for continued use at home.

According to another aspect of the invention, the kit provides one or more inserts which comprise one or more pain-relieving agents suitable for treatment of pain and a dental device provided with one or more electrical components suitable for enhancing or stimulating the effect of the pain relieving agent(s). One aspect of the invention is a kit provided with one or more inserts in which pain-relieving agent is at a concentration suitable for use in a dental surgery or suitable for use at home. Another aspect of the invention is a kit provided with one or more inserts in which pain-relieving agent is at a concentration suitable for use in a dental surgery and one or more inserts in which a concentration of pain-relieving agent is suitable for continued use at home.

According to another aspect of the invention, the kit provides one or more inserts which comprise electrical-stimulation-conducing formulation and a dental device provided with one or more electrical components suitable for electrically stimulating the teeth and/or gums. Such a kit maybe used for the relief of pain and/or for enhanced healing. One aspect of the invention is a kit provided with one or more inserts in which electrical-stimulation-conducing agent is at a concentration suitable for use in a dental surgery or suitable for use at home. Another aspect of the invention is a kit provided with one or more inserts in which electrical-stimulation-conducing agent is at a concentration suitable for use in a dental surgery and one or more inserts in which a concentration of electrical-stimulation-conducing agent is suitable for continued use at home.

According to another aspect of the invention, the kit provides one or more inserts which comprise plaque removing agents and a dental device provided with one or more electrical components (e.g. physical stimulation providing means and optionally one or more heat-providing means), said components suitable for assisting removing plaque (e.g. by physically stimulating the teeth and/or gums). Such a kit maybe used for the loosening plaque. One aspect of the invention is a kit provided with one or more inserts in which plaque-removing agent is at a concentration suitable for use in a dental surgery or suitable for use at home. Another aspect of the invention is a kit provided with one or more inserts in which plaque-removing agent is at a concentration suitable for use in a dental surgery and one or more inserts in which a concentration of plaque-removing agent is suitable for continued use at home.

According to another aspect of the invention, the kit provides one or more inserts which comprise healing agents and a dental device provided with one or more electrical components (e.g. physical stimulation providing means and optionally one or more heat-providing means), said means suitable for providing a healing effect (e.g. physically stimulating the teeth and/or gums). Such a kit maybe used for healing dental lesions. One aspect of the invention is a kit provided with one or more inserts in which healing agent is at a concentration suitable for use in a dental surgery or suitable for use at home. Another aspect of the invention is a kit provided with one or more inserts in which healing agent is at a concentration suitable for use in a dental surgery and one or more inserts in which a concentration of healing agent is suitable for continued use at home.

Examples of components of kits are provided in FIGS. 13 to 15. A kit of the invention may be provided with one or more or items depicted in FIGS. 13 to 15, with or without a dental device.

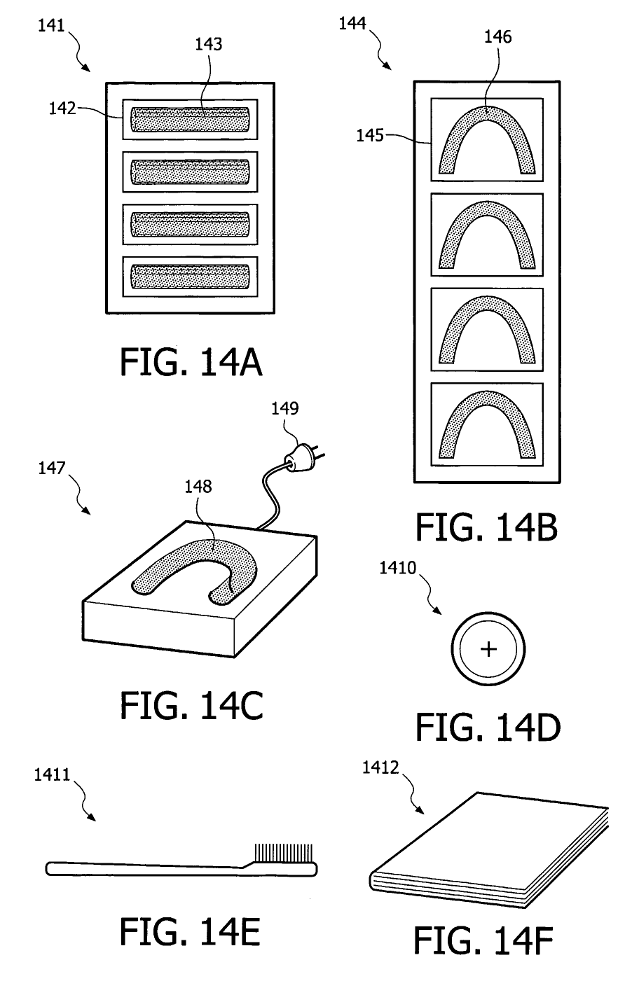

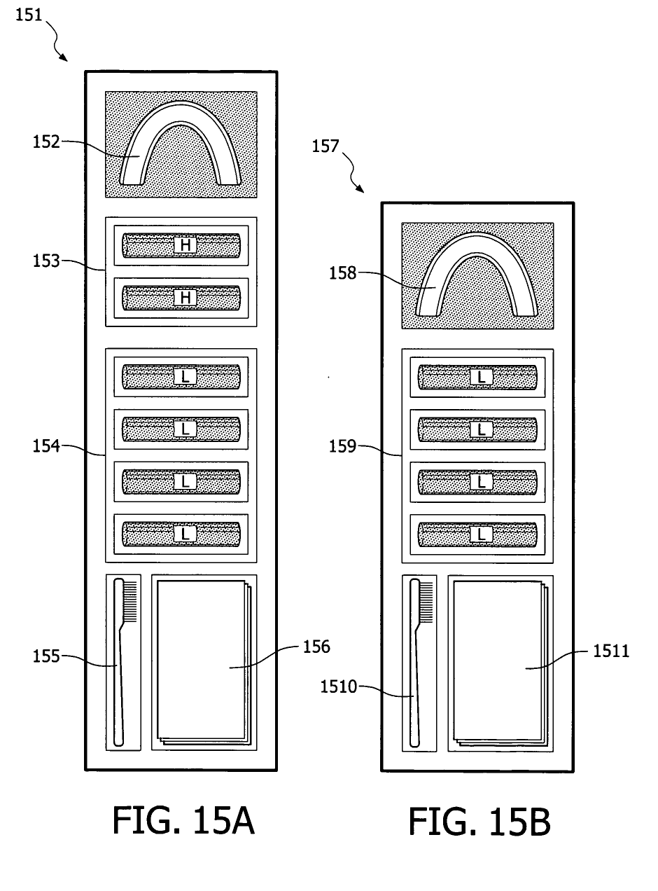

Examples of kits are shown in FIGS. 14 and 15.

A kit may be provided with any combination of inserts as disclosed herein and a dental device therein provided with any combination of electrical components. The inserts may further comprise a combination of agents for example one or more of pain-relief agents, tooth whitening agents, electrical-stimulation conducting agents, anti-bacterial agents, anti-bad breath agents etc. Thus a kit may be suitable for providing a combination of therapies such as, for example, bleaching and bed breath, or pain relief and enhanced healing.

### DETAILED DESCRIPTION OF THE FIGURES

The present invention is exemplified by the following figures which do not limit the scope of the invention. The Figures depict an ELD, LED or ultra sonic motor as the electrical component as illustrations of possible embodiments. However, this is no way excludes the possibility that one or more other electrical components may be incorporated into the device, or excludes other combinations of components. The ELD wire or ELD panel depicted below are readily interchangeable.

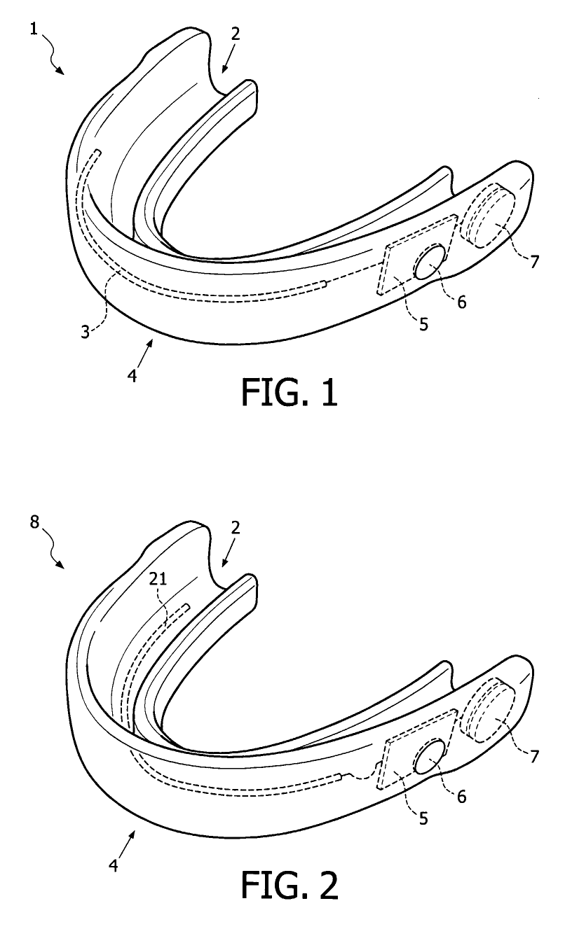

FIG. 1 shows a dental device I of the present invention comprising a trough 2, wherein an ELD wire 3 is disposed in the inner wall of the anterior 4 of the trough. Said electrical components, a regulating means 5, a switch 6, and one or more button batteries 7 are co-operatively connected.

FIG. 2 shows a dental device 8 of the present invention comprising a trough 2, wherein an ELD wire 21 is disposed in the inner wall of the based of the trough. Said electrical components, a regulating means 5, a switch 6, and one or more button batteries 7 are co-operatively connected.

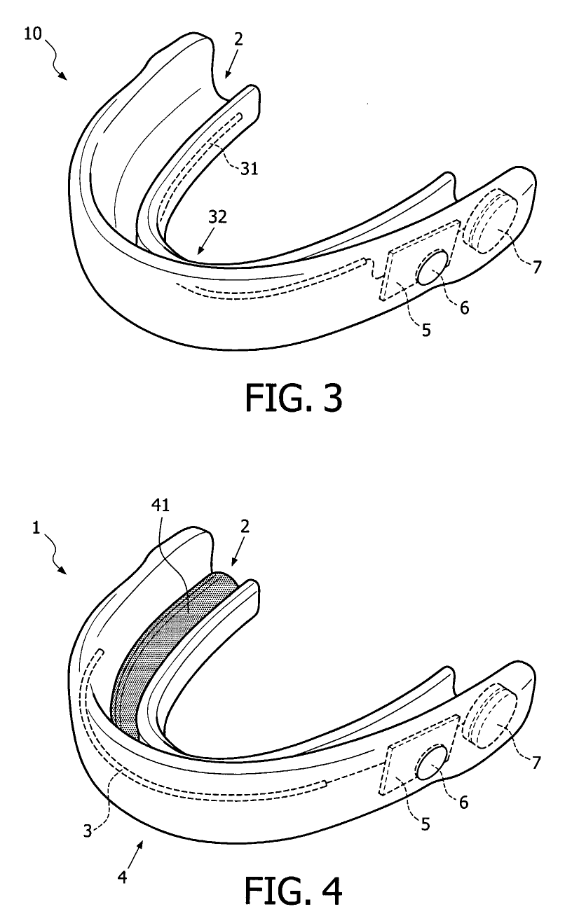

FIG. 3 shows a dental device 10 of the present invention comprising a trough 2, wherein an ELD wire 31 is disposed in the inner wall of the posterior 32 of the trough. Said electrical components a regulating means 5, a switch 6, and two button batteries 7 are co-operatively connected.

FIG. 4 shows a dental device 1 of the present invention as in FIG. 1 further comprising an insert 41 according to an embodiment of the invention, said inserted located in the base of the trough.

FIG. 5A shows a dental device 51 of the present invention comprising two troughs 52, 54 suitable for the immersion of both dental arches. An ELD wire 56 is disposed in the inner anterior wall of a trough 52 suited for immersion in the upper dental arch, and another ELD wire 57 is disposed the inner anterior wall of a trough 55 suited for immersion in the lower dental arch. In this embodiment of the invention, both sets of ELD wires, a single regulating means 58, said regulating means connected to a switch 59 and two button batteries 60 are co-operatively connected.

FIG. 5B shows a dental device 51 of the present invention comprising two troughs 53, 54 suitable for the immersion of both dental arches. One row of silicon heating elements 56 is disposed in the inner anterior wall of a trough 52 suited for immersion in the upper dental arch, and another row of silicon heating elements 57 is disposed the inner wall of the anterior of a trough 55 suited for immersion in the lower dental arch. The trough is further provided with four ultrasonic motors 510, 511, 512, 513 located towards the ends of the troughs, two of which vibrate the upper trough (511, 512), and two vibrate the lower trough (510, 513). In this embodiment of the invention, all the electrical components, a single regulating means 58, said regulating means being connected to a switch 59 and two button batteries 514 are co-operatively connected.

FIG. 6A depicts another example of a device according to the present invention and some of the main components therein. According to this embodiment, a device comprises a soft-form trough 61, having a channel 62 shaped to receive an insert. The device comprises a sub mould 68, which fits into the trough so forming part of a battery compartment 66. The sub mould 68 also provides support for battery contacts 67. A battery compartment cover 64 comprises a recess to accommodate part of the battery 65. An ELD panel 63 is positioned in the anterior wall of the trough.

FIG. 6B depicts an alternative view of the device as shown in FIG. 6A. An ELD panel is provided 63 and functionality is directed on to the anterior surface of the teeth and/or gums of the dental arch.

FIG. 6C depicts some of the main elements of a device as shown in FIG. 6A in an “exploded view”. Indicated are a soft foam mouth piece 61, ELD panel 63, battery 65, battery compartment cover 64, submould 68, which forms a part of a battery compartment 69, and battery contact 67.

FIG. 6D depicts another example of a device according to the present invention and some of the main components therein. According to this embodiment a device comprises a soft-form trough 61 and a sub mould 68, which fits into the trough so forming part of a battery compartment 66. The sub mould 68 also provides support for battery contacts 67. A battery compartment cover 64 comprises a recess to accommodate part of the battery 65. Ultrasonic motors 610, 611 are positioned in the anterior wall of the trough, so that physical stimulation therefrom is transmitted to the whole trough.

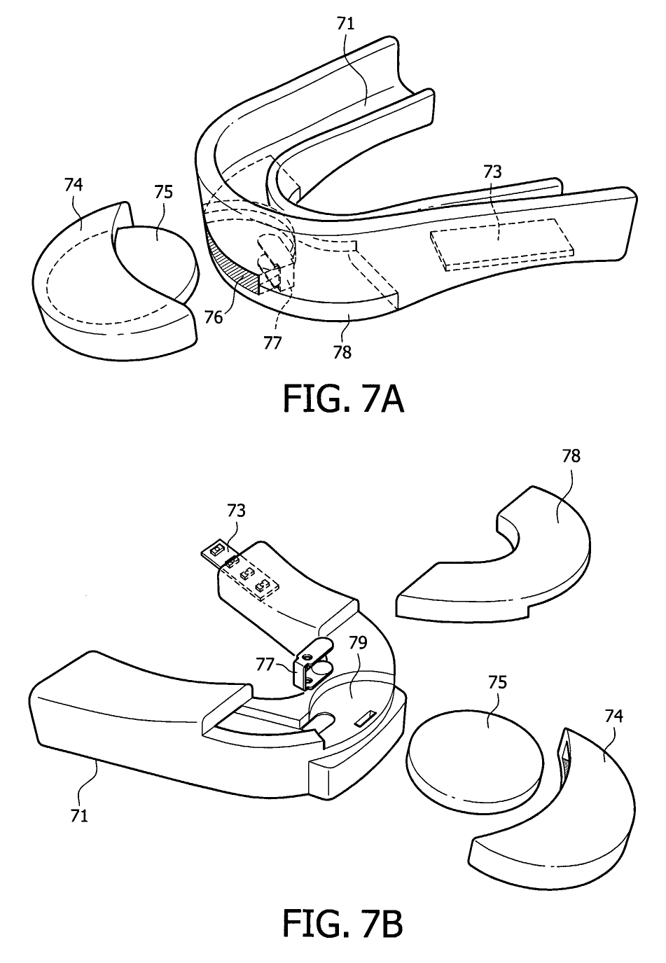

FIG. 7A depicts another example of a device according to the present invention and some of the main component therein. According to this embodiment a device comprises a soft-form trough 71 and a sub mould 78, which fits into the trough so forming a part of a battery compartment 76. The sub mould 78 also provides support for battery contacts 77. A battery compartment cover 74 comprises a recess to accommodate part of the battery 75. A support board on which components such as light producing LEDs are provided 73 is positioned in the wall of the base of the trough, so that light is projected therefrom towards the teeth and gums on the opposing dental arch.

FIG. 7B depicts some of the main elements of a device as shown in FIG. 6A in an “exploded view”. Indicated are a soft foam mouth piece 71, support board on which light producing LEDs. are mounted 73, battery 75, battery compartment cover 74, submould 78, which forms a part of a battery compartment 79, and battery contact 77.

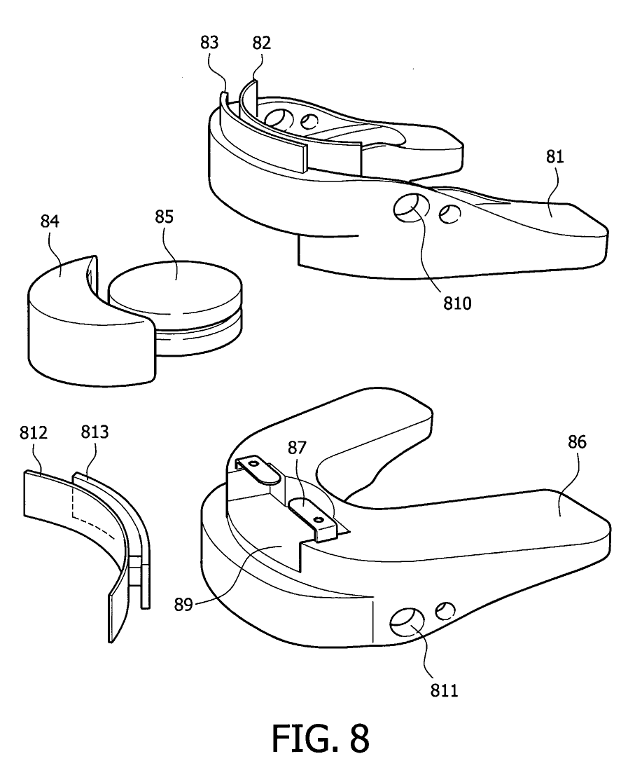

FIG. 8 depicts another example of a device according to the present invention and some of the main components therein. The exploded view depicts an upper trough comprises a soft-form trough 81, and an ELD panel 82 mounted on a circuit board 83. Air vent, one of which is indicated 810 assists with breathing through the mouth. A battery cover 84, two button batteries 85 are depicted. The lower trough comprises a soft-form trough 86, part of a battery compartment 89 and an ELD panel 812 mounted on a circuit board 813. The trough also provides support for battery contacts 87. Air vents 811 assist with breathing through the mouth.

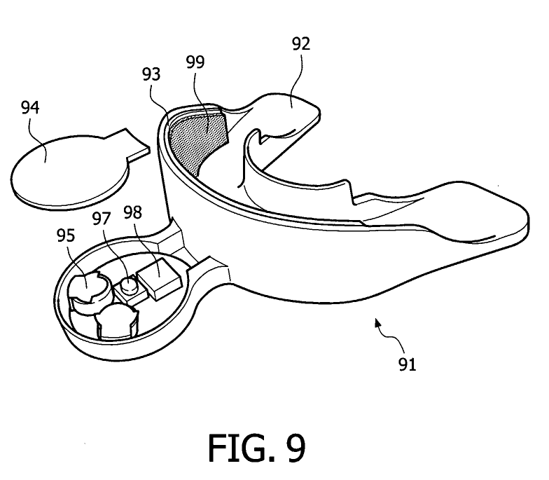

FIG. 9 depicts another example of a device according to the present invention 91 and some of the main components therein. The exploded view depicts a trough 92, an ELD panel 93, battery cover 94, two button batteries 95, a switch 97 and controller/inverter 98. A gel strip 99 is also depicted.

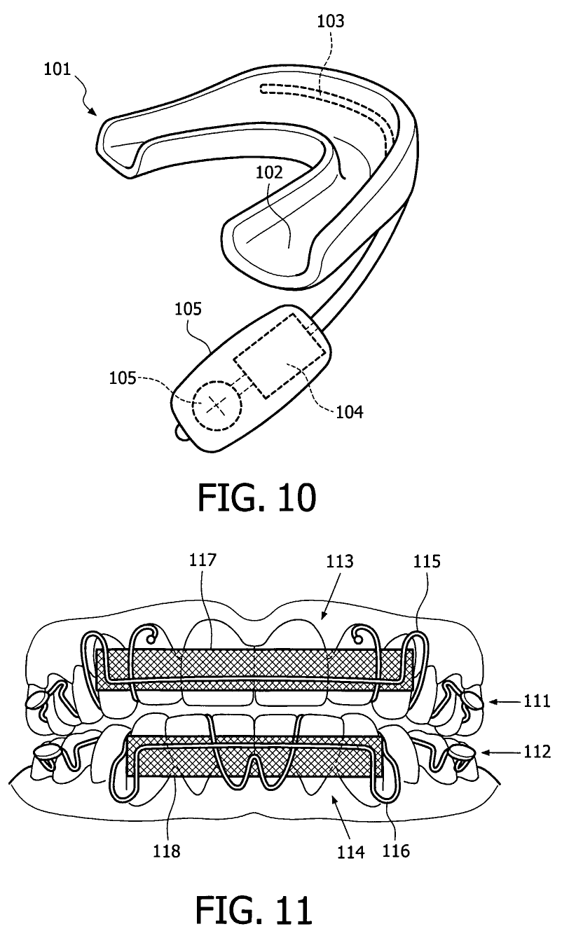

FIG. 10 depicts another example of a device 101 according to the present invention and some of the main components therein. The view depicts a trough 102, an ELD wire 103, a unit 105 comprising a button battery 105, and a controller/inverter 104.

FIG. 11 depicts other examples of devices according to the present invention, which are braces. A brace for the upper teeth 111, is shown in situ, attached to the upper jaw 113. A gel strip 117 is held between the brace and front teeth. An ELD wire 115 incorporated into the brace provides functionality. The same features are present in a brace 112 suitable for the lower teeth 114, which incorporates an ELD wire 116 in contact with a gel strip 118.

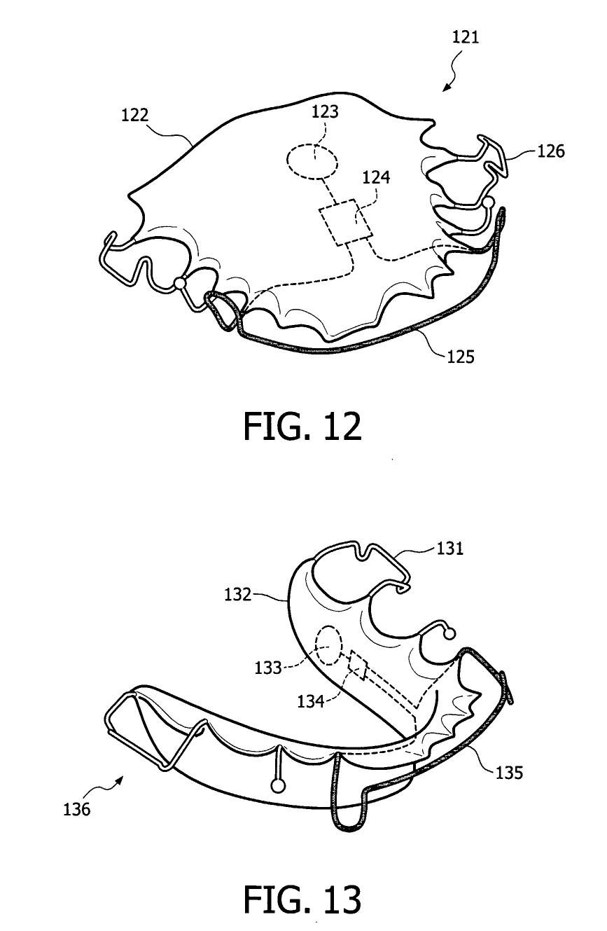

FIG. 12 depicts brace for the upper teeth 121. Wires such as 126 embedded in a plastic support 122 allow the brace to be clipped to the teeth. An ELD wire 125 incorporated into the brace provides functionality. The support holds a battery 123 and control/inverted 124 which are co-operatively connected to the ELD wire 125.

FIG. 13 depicts brace for the lower teeth 136. Wires such as 131 embedded in a plastic support 132 allow the brace to be clipped to the teeth. An ELD wire 135 incorporated into the brace provides functionality. The support holds a battery 133 and control/inverted 134 which are co-operatively connected to the ELD wire 135.

FIG. 14A shows a package 141 of four straight, tube shaped inserts 143, each insert provided in its own sealed pouch 142.

FIG. 14B shows a package 144 of four trough-shaped inserts 146, each insert provided in its own sealed pouch 145.

FIG. 14C shows a charging/programming device 147 disposed with a mains plug 149, and a U-shaped station 148 for receiving a dental device.

FIG. 14D shows a button battery 1410 for use in a dental device

FIG. 14E shows a cleaning brush 1411, which may be used to clean a trough of a dental device

FIG. 14F depicts an instruction booklet 1412, which explains the device, use and inserts to a subject and/or dental professional.

FIG. 15A depicts a kit 151 for the professional and continued home whitening of teeth according to the invention, comprising a dental device 152, inserts comprising a professional-use (High) concentration of bleaching agent 153, inserts comprising a home-use (Low) concentration of bleaching agent 154, a cleaning brush 155, and an instruction booklet 156.

FIG. 15B depicts a kit 157 for the professional and continued home whitening of teeth according to the invention, comprising a dental device 158, inserts comprising a home-use (Low) concentration of bleaching agent 159, a cleaning brush 1510, and an instruction booklet 1511.

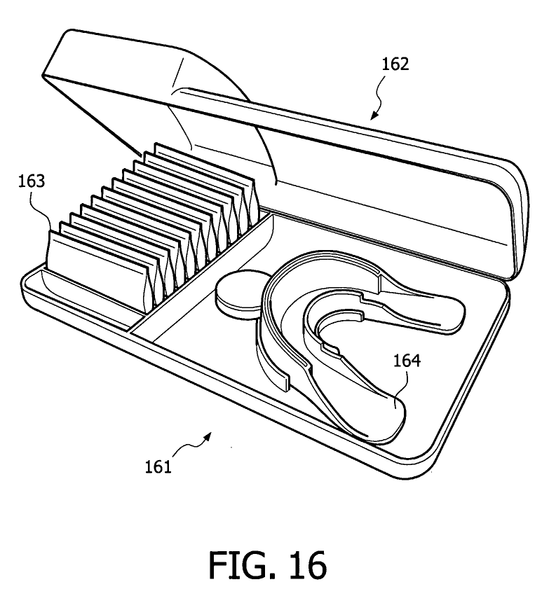

FIG. 16 depicts a kit 161 for home whitening of teeth according to the invention, comprising a dental device 164, gel strip 163, contained in a hinged box 162.

1. A dental device for treatment of teeth comprising:
(a)—a trough, shaped for the immersion of teeth and/or gums of a dental arch, or
—a dental brace, shaped for attachment to the teeth of a dental arch, and
(b) one or more electroluminescent devices, ELDs, positioned such that light is directed towards the anterior surface of said teeth and/or gums.

2. The dental device according to claim 1 wherein the light emitted from an ELD pulsates.

3. The dental device according to claim 2 wherein the frequency of said pulsation is between 1 and 500 times per second.

4. The device according to claim 1 wherein the number of ELDs is two or more and said ELDs illuminate in patterned sequence.

5. The dental device according to claim 1, further comprising one or more reflectors.

6. The dental device according to claim 1, further comprising one or more power sources.

7. The dental device according to claim 6 wherein said power source is one or more batteries.

8. The dental device according to claim 1 further comprising a means for connection to an external power source.

9. The dental device according to claim 8 wherein said external power source is an electric toothbrush.

10. The dental device according to claim 1 further comprising an inverter.

11. The dental device according to claim 1 further comprising one or more switches.

12. The dental device according to claim 1 further comprising one or more means to regulate said electrical components.

13. The dental device according to claim 1 further comprising one or more means to provide functionality for a timed period, after which time, the device switches off.

14. The dental device according to claim 1 wherein said trough or brace has a means to receive or support an insert comprising one or more agents.

15. The dental device according to claim 1, further comprising at least one Light Emitting Diode, LED.

16. The dental device according to claim 15 wherein the number of visible LEDs is two or more and said LEDs illuminate in patterned sequence.

17. The dental device according to claim 1 wherein said ELD or LED where present emits light of a wavelength suitable for curing dental restorative materials.

18. The dental device according to claim 1 wherein said ELD or LED where present emits light of wavelength between 400 to 510 nm.

19. The dental device according to claim 1 wherein said ELD or LED where present emits light of a wavelength suitable for enhancing the activity of one or more bleaching agents.

20. The dental device according to claim 15 wherein said LED emits heat.

21. The dental device according to claim 20, further comprising at least one means for providing heat stimulation.

22. The dental device according to claim 21 wherein said means to provide heat stimulation is a heating strip comprising one or more heating elements.

23. The dental device according to claim 1, further comprising at least one means for providing physical stimulation.

24. The dental device according to claim 23, wherein a means to provide physical stimulation is an ultrasonic transducer.

25. The dental device according to claim 23, wherein a means to provide physical stimulation is an ultrasonic motor.

26. The dental device according to claim 23, wherein a means to provide physical stimulation is a magnetic motor.

27. The dental device according to claim 1, further comprising one or more protrusions capable of abrasive cleaning, massaging and/or polishing teeth and/or gums.

28. The dental device according to claim 1, further comprising at least one means to provide electrical stimulation.

29. The dental device according to claim 28 wherein said means to provide electrical stimulation is a pair of electrodes.

30. The dental device according to claim 1, further comprising one or more selected from one or more LED, means for providing heat stimulation, means for providing physical stimulation, and/or means to provide electrical stimulation wherein said ELD, or where present, one or more of said LED, means for providing heat stimulation, means for providing physical stimulation, and/or means to provide electrical stimulation is positioned such that its' functionality is directed towards the anterior surface of said teeth and/or gums.

31. The dental device according to claim 1, further comprising one or more selected from one or more LED, means for providing heat stimulation, means for providing physical stimulation, and/or means to provide electrical stimulation, wherein said ELD, or where present, one or more of said LED, means for providing heat stimulation, means for providing physical stimulation, and/or means to provide electrical stimulation is positioned such that their functionality is directed towards the top surface of said teeth and/or gums.

32. The dental device according to claim 1, further comprising one or more selected from one or more LED, means for providing heat stimulation, means for providing physical stimulation, and/or means to provide electrical stimulation, wherein said ELD, or where present, one or more of said LED, means for providing heat stimulation, means for providing physical stimulation, and/or means to provide electrical stimulation is positioned such that their functionality is directed towards the posterior surface of said teeth and/or gums.

33. The dental device according to claim 1 in which the device comprises a trough, further comprising a second device comprising a trough shaped for the immersion of teeth and/or gums of a dental arch, said second device arranged so that the teeth of both the upper and lower arches are each immersible in a trough.

34. The dental device according to claim 33 wherein a single switch and/or regulating means are provided.

35. The dental device according to claim 1 wherein at least part of the device is made from a translucent material allowing light from said ELD or LEDs to be viewed from the anterior of said device.

36. The dental device according to claim 1, wherein at least part of the device is made from one or more of the following materials: coloured polymer, patterned polymer, composite, translucent polymer, opaque polymer.

37. A method for curing light-curable dental materials comprising applying a dental device according to claim 1.

38. A method for bleaching teeth comprising applying a dental device according to claim 1 to the teeth.

39. The method according to claim 38, further comprising placing an insert comprising one or more bleaching agents into the dental device.

40-47. (canceled)

48. An insert comprising one or more agents, wherein said insert has a means for receiving functionality of at least one electrical component of a device according to claim 36.

49. The insert according to claim 48, comprising a means for reciprocating with a receiving or supporting means of the dental device.

50. The insert according to claims 48, wherein the one or more agents comprise at least one bleaching agent.

51. The insert according to claim 50 wherein the at least one bleaching agent is hydrogen peroxide.

52. The insert according to claim 51 wherein said hydrogen peroxide is at a concentration of between 6 and 15%.

53-71. (canceled)

72. A method for providing dental treatment comprising applying the dental device according to claim 36.

73. The method according to claim 72 further comprising the steps of
activating the device,
receiving treatment for a fixed time period, after which time the device automatically stops, and
repeating treatment a number of times, or until the power source runs out.

74-75. (canceled)

76. A kit comprising a dental device according to claim 1 and at least one insert.

77-78. (canceled)

79. The device according to claim 1 wherein at least one ELD and, where present, LED is provided on or in the outer wall of the base of the trough, and the light emitted therefrom is directed towards the opposing dental arch.

80-83. (canceled)

84. The insert according to claim 49, wherein the one or more agents comprise at least one bleaching agent.

85. The insert according to claim 84 wherein the at least one bleaching agent is hydrogen peroxide.

86. The insert according to claim 85 wherein said hydrogen peroxide is at a concentration of between 6 and 15%.
